(19) United States
(12) Patent Application Publication
(10) Pub. No.: US 2017/0259167 A1
(43) Pub. Date: Sep. 14, 2017

(54) BRAINWAVE VIRTUAL REALITY APPARATUS AND METHOD

(71) Applicants: Nathan Sterling Cook, Santa Maria, CA (US); Daniel Reed Cook, Bountiful, UT (US)

(72) Inventors: Nathan Sterling Cook, Santa Maria, CA (US); Daniel Reed Cook, Bountiful, UT (US)

(21) Appl. No.: 15/457,681

(22) Filed: Mar. 13, 2017

Related U.S. Application Data
(60) Provisional application No. 62/307,578, filed on Mar. 14, 2016.

(51) Int. Cl. A63F 13/212; A63F 13/73; A63F 13/42

(52) U.S. Cl. CPC A63F 13/212; A63F 13/42; A63F 13/73; A63F 2300/8082

(57) ABSTRACT

New human bio-sensors in a virtual reality headset can be worn comfortably for extended periods of time, detecting brain, nerve, ocular, muscle or other bio-signals. Recording raw data, amplification, digital conversion, filtering, support subsequent manipulation by iteratively creating multiple interpretation maps. Data processing and transmission are reduced so that control of a remote device may occur in real time, based on an event in the body of a wearer. A signal interpretation engine iteratively creates numerous interpretation maps, the best correlated one being used exclusively, thus minimizing false positives and requiring minimal data to distinguish an event from any other non-presence of that event. After training and verification, operation in real time processes live, continuous data to control a remote device based on the events detected by the sensor set in a headset, arm bands, leg bands, gloves, or boots.

### RELATED APPLICATIONS

This application claims the benefit of U.S. Provisional Patent Application Ser. No. 62/307,578, filed Mar. 14, 2016, which is hereby incorporated herein by reference with its Appendices attached thereto and filed therewith. Also, this patent relies on information from U.S. Pat. No. 6,546,378, issued Apr. 8, 2003, entitled SIGNAL INTERPRETATION ENGINE, as well as U.S. Pat. No. 6,988,056, issued Jan. 17, 2006 entitled, SIGNAL INTERPRETATION ENGINE, both of which are hereby incorporated herein by reference in their entirety.

### BACKGROUND

1. Field of the Invention

This invention relates to computer systems and, more particularly, to novel systems and methods for remote control of devices, based on biological sensors as input devices detecting muscular and brain activity of a wearer, and processing “big data” to do so in real time.

2. Background Art

The term “big data” may not be well defined, but acknowledges an ability to collect much more data than can be readily processed. Data collected during any period of “real time” may still require months of programming, mining, and study to determine its meaning. When data is noisy, having a comparatively small signal-to-noise ratio (SNR), the problem is exacerbated. Modern gaming systems can calculate, render, download, and display images in extensive detail. Programming to do so can be done over a period of months or years. Not so, detecting and processing user actions.

Virtual reality is a term that is used in many contexts. It may not have a universal definition. Nevertheless, it may typically be thought of as an immersive sensory experience. An individual can look at a sculpture or work of art. An individual may watch a movie (the original motion picture), and may hear sounds directly or as reproduced through speakers.

Permitting an individual to control what is seen is an objective of gaming systems. By moving a controller wand, controller handle, buttons, and the like, a user may “virtually fly” an aircraft, or play golf, tennis, or music. Most recently, gaming software is attempting to improve the user experience in the details. One approach is to provide a user with a screen (monitor) in a comparatively smaller format such as in goggles or a headset or the like. To that end, headsets have been subject to certain experiments to embed cameras observing the wearer. The cameras have the objective of taking images of the face or portions of the face of a user.

The difficulty lies in trying to process those images, and transmit the information in them to a remote location of another gamer. Each player needs to receive those images and thus be able to see a representation of the face, body, limbs, etc. of a fellow gamer, typically an opponent. However, such image processing requires massive computational resources. Moreover, computation of resources does not respond instantly. It requires time to process information.

Thus, it would be an advance in the art to provide less processing or a lesser processing requirement for information passed over a network to a remote location, such as a computer console of a fellow gamer. It would be an advance in the art to be able to find new electrical and mechanical mechanisms for collecting data, new methods for processing data, and new methods for consolidating and summarizing data in order to reduce memory requirements in computing systems and storage devices, as well as improving the speed of processing in order to provide literal “real-time” processing and transmission of user activities to a remote user or fellow user in a gaming environment.

### BRIEF SUMMARY OF THE INVENTION

In view of the foregoing, in accordance with the invention as embodied and broadly described herein, a method and apparatus are disclosed in one embodiment of the present invention as including a brainwave engine operably connected to a virtual reality headset or brainwave virtual reality headset (BVRH). In certain embodiments, the brainwave engine may incorporate all or part of a signal interpretation engine as described in detail in the references incorporated herein above by reference.

Some valuable features or functionalities for a BVRH may include a system for labeling events, collecting electronic data such as encephalo-based (electroencephalographic; brain based or neuro based) data, as well as myo-based (electromyographic; muscular) data or ocular-based (electroocular; eye dipole detection). In a system and method in accordance with the invention, such data are collected through sensors, and may be allowed to be entirely mixed. By adapting a signal interpretation engine according to the invention, iterating to provide signal interpretation maps, and correlating to find the best such map, processing may be greatly speeded up. Processing and control may be done in real time. Also, separation of myo-, encephalo-, and ocular-based data may be done by processing, rather than by limiting sensors.

In one presently contemplated embodiment of a system in accordance with the invention, biological sensors may collect data, such as voltages between a reference and a sensor, and between a neutral electrode and a sensor in order to provide raw data. This data may then be manipulated, by one of many mathematical processes in order to determine, and initially simply process, the wave form by many, hundreds or thousands of mathematical processing manipulations.

The attempt is to observe and analyze a wave form by modifying it in a way that permits the detection of portions of the signal that correspond to an event coincident with the data. Since the signal-to-noise ratio is so small, the noise tends to dominate. By using manipulations and processes in accordance with the signal interpretation engine, one my then analyze correlations between events and processed signals. Thus, interpretation maps may be created, and tested for their best correlation against events.

Thus, a BVRH may take data from a subject (user) and process that data in order to provide an interpretation map, and select the best correlating interpretation map for sensor data. Thereafter, the system may use the interpretation map, which involves rapid pass through analysis of wave forms taken live during operation of a game or other event, and quickly assess them, categorize them, and output data that will control an avatar or other device according to the biological activity of the wearer of the BVRH.

Thus, the immersive virtual reality experience may be augmented with an augmented reality to form a blended reality device in which some signals are based on actual events, others on virtual events, and yet others are responses to either type of event by a user. All of which may be shared between internetworked devices.

In one currently contemplated embodiment, a headset may include a head mounted display (HMD) such as goggles, helmet, lighter headgear, such as straps, and the like. A user may wear a headset containing a set of sensors. Sensors may be of a variety of devices, including capacitive, temperature, electromagnetic, or the like.

In one embodiment, sensors may include electrodes that are monitored for voltages with respect to some source, such as a reference voltage, ground, or both. In one currently contemplated embodiment, biological events may be monitored through sensors.

For example, biological events may include a smile, a smirk, a teeth clench, a grimace, a blink, a wink, an eyebrow raise, an eyebrow lowering, any of these events may occur with respect to a single eye or both eyes. In general, the biological event of interest may be any activity in the face or head of a user that is detectable by a sensor. Thus, biological events may be simple, such as raising an eyebrow or both eyebrows. Similarly, events may be complex, such as a teeth clench which involves many muscles in the face, and may involve furrowing of the brows simultaneously, narrowing of the eyes, and so forth. Some events may be effectively binary, such as whether an eye is open or closed. On the other hand, a biological event may be partial, proportional, or multi-state in nature.

For example, a teeth clench, a grimace, or the like will typically involve the entire face. It may involve the eyes being partially closed, the brows being depressed, the mouth converted into a frown, or the clenching of teeth or both, and so forth. Thus, multiple states of multiple portions of the face of the user may effectively result in a multi-state event. This is particularly so when the specific aspect of the face, such as an eyebrow, the corner of a mouth, a chin, or the like may be involved or not involved in a particular expression.

Accordingly, biological events may be isolated. Especially during learning, it may be beneficial to actually record information in which an event is being recorded in isolation. In particular, if one particular aspect of a face is being activated by a user, such as a smirk, which will typically involve only one side of the mouth being elevated in a smile, then events may be intentionally isolated by a user in order to provide a more pure or isolated signal. Nevertheless, in actual practice, multi-state events may occur, which then must be interpreted, with various aspects of a face being identified and classified into a state.

For example, a smile may be a readily smile, a pleasant smile of enjoyment, or a diabolical smile. These may be identified as different types of events. By having isolated events recorded, the system in accordance with the invention may be able to put together the state of multiple portions of the face or multiple signal sources. Meanwhile, in some events, a particular part of the body may have multiple states of existence itself. Again, a brow raise, a brow lower, or the motion of the brow into any location therebetween may constitute an event or portion of the event to be recorded, and identified as such. Thus, compound events may be events in which multiple aspects of the head or face of a user are involved.

Similarly, biological events may involve activation of muscle cells in the body. Sensors may be secured to arms, elbows, portions of an upper arm and forearm, locations both inboard and outboard from an elbow. Likewise, hands may be instrumented. Gloves with sensors may be used. Feet, knees, and the like may record running in place, muscle stretch, muscle tensing, and so forth. In general, biological sensors may record biological events in any portion of the body, based on activity or nerves, or activity of muscles.

In one currently contemplated embodiment, biological events may be recorded in especially conformal sensors. For example, electroencephalograms are used in medicine to detect whether certain portions of the brain are active. Similarly, electrocardiograms may record signals sent by the heart. In general, electromyograms may distinguish or identify muscular activity. In a system in accordance with the invention, one may think of these all as sources of signals to be sensed and collected together. They may detect electromagnetic signals, voltages, current, strain, or the like. Sensors may be formed in various ways. However, a system and method in accordance with the invention, sensors may be formed of a flexible, electrically conductive fabric material. This fabric may be backed with a solid foil conductor that is comparatively thin enough not to distort the fabric yet hold a connector. Prior art systems may require probes that impose directly into the brain or into the skin, plate-like or pointed metal objects that press themselves into the skin or depress the skin uncomfortably. Stiff metal plates or points that may be pressed or glued to the skin in an uncomfortable manner are to be avoided herein.

In an apparatus and method in accordance with the invention, a soft flexible, yet electrically conducting, fabric may be backed by a better conductor, such as a thin foil that makes electrical contact along a considerable extent of the area of the softer fabric material. These conductor foils may then be secured at some location away from the skin of a user, to connectors that can then receive wires for carrying signals. Signals, the contact surface of the skin of a user through the fabric, conducting foils, and connectors may be transmitted by wires to amplifiers. Those amplifiers may then convert signals through analog-to-digital converters (A-DC). Digital signals, now representing the voltage, between sensors and a reference, being reported into a computing system to be operated on as raw data. Processing may include registration of signals in order to establish certain locations within an event that correspond to certain locations within the wave form that is the signal.

For example, typically, during a training process, a trigger, signal, button, or the like may be actuated in order to identify an event. Typically, during training, an event is typically actuated, known, and recorded. Accordingly, sensors and their signals may be recorded with time stamps, time signals, clock identification, or the like corresponding to an event.

Thus, a record may include the identification of a time stamp at which time a trigger is activated. Following the trigger activation, then the biological event occurs, causing signals to be detected by sensors, passed on through the process. Accordingly, time stamps on the event record and on sensor data may thus be managed, in order to provide some identification of an event and what that event is, along with the beginning and ending times of such an event, of which match the sensor data.

In this way, sensor data may be absolutely associated, corresponded, and so forth to an event. The event, of course, is one of the biological events discussed hereinabove.

A computing system receiving the data in digital form and the event record identifying the event, its start time and end time, may then process the information to register the event in time with the sensor data.

For example, in one embodiment, a user, training a system in accordance with the invention may upon a triggering signal, make a smile. That smile may be held for some amount of time. It may then be relaxed. By providing a start time closely following a trigger signal, and by providing a hold time that clearly will occupy the central portion of a time region, then registration of the data may be made between the beginning and end times of the event record and corresponding sensor data, knowing that the non-event condition exists followed by a transition into the event condition, followed by a transition out of the event condition, followed by “dead space” in which the event does not exist in the data. Thus, registration of the data may permit comparative to absolute certainty as to what the state of an event is that corresponds to certain portions of the signal wave form.

Thereafter, in a system and method in accordance with the invention, the classification process may involve a comparison between various events after classification. For example, in certain embodiments, it is discussed in detail in the references incorporated hereinabove by reference, in a particular feature expansion may be applied to the data corresponding to an event. Then that feature expansion may be correlated with the event. This may be done hundreds of times.

Eventually, the correlations of an event to the processed expansion or feature expansion may then result in various accuracy of the correlations with the event. Eventually, it has been found best to select a particular interpretation map that provides the best correlations found. Thereafter, raw data may be received in a verification mode or operational mode, which may be processed in real time, using that best interpretation map. It has been found best not to use multiple interpretation maps, but rather than rely on a single, best correlated interpretation map in a system in accordance with the invention.

In operational mode, the interpretation map may then be used as events are tracked. A user may use a headset, and let events occur naturally throughout a gaming or other experience. Events are accordingly picked up by sensors, amplified, converted to digital signals, and sent to a computer for processing. A computer then does the classification process on raw, unknown data, and thereby determining what events the interpretation map assigns to the incoming data.

The classification process then provides outputs to go over a network to operate a remote device. That remote device may be an avatar visualization on a screen, a character in a scene on a monitor of a game, or even a controller for a device, such as an electromechanical device. Likewise, any other electronically controllable, remote device may be operable. It has been found that actual facial expressions may be used to control a device between states, or control movement of an object in multiple directions based on actuation by a user making facial expressions.

In other embodiments, sensors in accordance with the invention may be attached to a sleeve on an arm of a user, on the leg of a user, or the like. In currently contemplated embodiments, a sleeve containing sensors may fit on an upper arm, elbow, and forearm of a user. Similarly, such a sleeve may be fitted to an arm, foot, hand, elbow, knee, or other bodily member of a user. Thus, data reflecting movement of a subject may be processed and sent to control an image represented that user. Thus, in a virtual reality headset screen (monitor) one individual may view several other individuals, mutually gaming, as each is represented by an avatar or person constructed by the computer on a screen, and actually performing the motions of the subject gamer in each case. This can operate in real time, since the processing is sufficiently fast with an interpretation map that has been made in advance, and a machine has been “trained” according to knowing events or actions on the part of a subject.

It has been found that in some circumstances, particularly because the sensors may detect both myographic as well as encephalographic data, that high impedance amplifiers seem to provide important function. Moreover, the use of filters may occur in a processing center, which may be programmed into a remote computer, or as in various prototype developments can be manufactured and included in the headset without adding substantial additional weight or volume to the requirements of the headset. Signals may be communicated by wire or wireless communication systems and still provide rapid, accurate, real-time interpretation of biological activity by processing of the biological signals corresponding to biological activities.

In one currently contemplated embodiment of a BVRH, multiple, comfortable conductive fabric sensors may be held against the face or other body locations of a user. These may be secured in a dry contact method by polymeric foam pads that gently urge the soft fabric against the skin of a user. Thus, cushioning is provided. Moreover, a substantially constant force in contact may be maintained in spite of movement of the bodily parts of a subject. This may be especially valuable for the use over extended periods of time, where conventional sensors, electrodes, and the like are uncomfortable, and interfere.

In certain embodiments of a system in accordance with the invention, a smartphone, may be referred to as a “screen or monitor” may be inserted into the front of a headset, and used as a display. Moreover, multiple views (images) or perspectives may be presented on different halves of a smartphone, providing a stereoscopic image. Images may be transmitted through ocular pieces such as suitable optics comprising lenses effective to render the stereoscopic presentation of the smartphone focused to the eyes of a user wearing a headset.

On the other hand, displays may be independent of smartphones, and completely self-contained. However, a large contingent of youthful users rely on applications on smartphones for gaming. The cost-effective headset may include simple optics, in a goggle-like headset, held onto the face with headgear. A lateral strap may pass around the circumference of the head, a vertical strap proceeding from the top of the headset to the rear of the head to stabilize with the lateral strap. Thus, the lateral strap may be thought of as occupying the location of the crown of a hat or the hat band of the hat would occupy, whereas the vertical strap proceeds from the front of the head to the back of the head to stabilize the headset.

In certain embodiments, sensors may be electromyographic, electroencephalographic, or EOG type sensors. Likewise, strain sensors (stretch sensors, bending sensors) may be used. These are typically based upon resistance or electrical conductivity due to matrices or arrays of material such as rubber or elastomeric materials containing conductive particles, such as carbon, and so forth.

Certain other biological sensors, such as skin microstructure sensors may also be used to detect stresses, strain (engineering terms used herein as engineering terms, stress reflecting force per unit area, and strain reflecting length of extension per unit length. Herein whenever sensors are discussed, or brainwave sensors, any type of biological activity detection sensor may be used.

Thus, in summary, multiple sensors in a BVRH may detect, report or transmit, and record for measurement signals generated by electrical activity, electromagnetic activity, or both of the human head, brain, face, nerves, muscles, in any bodily member, such as arms, legs, and so forth. These biological signals may be mixed including electroencephalography (EEG) from the brain, electromyography (EMG) of the muscles of the face, head, neck, eyes, jaw, tongue, body, extremities, arms, legs, feet, hands, and so forth. Similarly, electrooculography (EOG), movement of human eyes, can also be detected. Any electrical activity or electromagnetic activity (sensible by induction coils, or the Lorenzo effect) may provide a signal useful to detect and report activation and activity of any human bodily member.

These multiple-wave form signals may be recorded simultaneously through sensors that detect through the soft, flexible, conductive fabric sensors. These may touch and press gently onto and into the skin, the degree of comfort that it may be maintained for extended periods, such as hours. Signals may be amplified continuously, digitized at a high rate, typically sufficient to detect accurately in the range of 256 Hertz or higher. As a practical matter, it has been found that encephalography requires a comparatively lower frequency zero to less than 50 Hertz, while myography typically requires or results in a comparatively higher frequency signal in the range of from about 50 to about 100, 90 being typical. Thus, radio transmission, such as Bluetooth and the like, Wi-Fi transmissions, near-field, or other wireless or wired data transmission through USB, HTMI, Ethernet, and the like may operate as connections to the brainwave engine hosted on a computer responsible to process, record, and interpret real-time data. Similarly, during learning, more complex signals requiring more processing time may be handled offline, following recording of events and their data.

In one embodiment, an apparatus may comprise a set of sensors, each sensor thereof comprising a fabric selected to be electrically conductive and to have a hardness approximating that of flesh of a subject. It may include a set of leads, operably connected to the sensors away from the subject, a signal processor operably connected to the leads to detect electrical signals originating at the set of sensors and convert those electrical signals to input signals readable by a computer, and a first computer system. That computer system may be operably connected to receive from the signal processor the input signals and programmed to iteratively create a plurality of interpretation maps corresponding the input signals with events representing activities of the subject. It may be programmed to minimize data processing by selecting a single interpretation map and determining events corresponding to the electrical signals based on the single interpretation map. It may also be programmed to send to a second computer system remote from the first computer system a control signal instructing the second computer system to perform an action, based on the events represented by the input signals.

The second computer system may include display, as may the first. The action may be a servo control or actuation of a machine or hardware. It may control re-creating an image of the events on the display of a remote second computer.

Sensors are applied to contact the face of a subject in a location selected to include at least one of above, beside, and below the eyes of the subject, the forehead below a hairline, between the eyes and the ears, and the cheeks proximate the nose and mouth of a subject. The second computer may be or include a controller of a device based on the events detected by the sensors.

An initial signal processor may have an amplifier corresponding to each of the leads, a converter from an analog format to a digital format readable by the first computer system.

An appliance fitted to be worn by a subject on a bodily member of the subject may provide the set of sensors secured to the appliance to be in contact with skin of the subject. The sensors may be in contact exclusively by virtue of pressure applied to the skin by the appliance. The appliance may be selected from headgear, clothing, a sleeve wrapping around the bodily member, a glove, a sock, a boot, a band or the like, to apply sensors to bare skin on the face or limbs of a subject. Pressure may be applied by the appliance completely encircling a perimeter of a bodily member, with elastomeric resilience providing a comfortable force to apply pressure.

One appliance comprises a mask contacting a face of a user and comprising a display portion and a sensor portion, the mask including a pressurizing material between the display portion and the sensor portion to apply pressure to the sensors against the skin.

A first computer is programmed with a signal interpretation engine, executable to create a signal interpretation map providing a manipulation of the signals effective to identify the event, based on the manipulation, an iteration algorithm to execute the signal interpretation engine repeatedly to create a plurality of signal interpretation maps, and a correlation executable effective to determine a best signal interpretation map of the plurality of signal interpretation maps.

The first computer is programmed to receive operational data from the set of sensors in real time and process the operational data by using the best signal interpretation map to identify the events occurring at the first set of sensors. It may then send to the second computer instructions controlling the remote device based on the events occurring at the first set of sensors.

In one embodiment, a set of sensors, each sensor thereof comprising a fabric having a hardness less than that of skin of a human. The sensors may be further characterized by an electrical conductivity sufficiently high to conduct an electrical signal therethrough. Leads connecting to sensors corresponding, respectively, thereto, conduct electrical signals from the corresponding sensors. An initial signal processing system operably connected to the leads has at least one of an amplifier, an analog-to-digital converter, and a filter, and may have an amplifier and A-D converter for each lead.

A first computer system operably connected to the initial signal processing system may execute any or all of a learning executable, a verification executable, and an operational executable. The learning, verification, and operational executables each comprise executable instructions effective to identify, and distinguish from one another, multiple events, each event of which corresponds to a unique set of values, based on the computer signals received by the computer system and corresponding directly with the electrical signals originating from the set of sensors.

The first computer system should be programmed to iteratively create a plurality of interpretation maps corresponding to the input signals and the events representing activities of the subject. It may minimize data processing by selecting a single interpretation map and determining the events corresponding to the electrical signals based on the single interpretation map. It is programmed to send to a second computer system remote from the first computer system a control signal instructing the second computer system to perform an action, based on the events represented by the input signals.

The first and second computer systems may each comprise a display. The second display by re-create an image representing the events detected by sensors corresponding to or attached on the first display. The second computer may be or control a device in a manner based on the events. A signal processor with an amplifier corresponding to each of the leads, and a converter converting each of the electrical signals from an analog format to a digital format, renders the signals readable by the first computer system.

An apparatus may include an appliance fitted to be worn by a subject on a bodily member of the subject, the set of sensors being secured to the appliance to be in contact with skin of the subject exclusively by virtue of pressure applied to the skin by the appliance. The appliance may be selected from headgear, a head-mounted display, a head-mounted audio-visual playback device, clothing, a sleeve wrapping around the bodily member, a glove, a sock, a boot, a mask, and a band that completely encircles a perimeter of the bodily member, a harness combining an array of electrical sensors and motion sensors, a harness containing sensors and stimulators applying electrical stimulation, the appliance including a pressurizing material to apply pressure to the sensors against the skin of the subject.

When the first computer is programmed with a signal interpretation engine, executable to create a signal interpretation map providing a manipulation of the signals effective to identify the event, events are distinguished based on the manipulations described in the references incorporated hereinabove by reference. However, this is done iteratively, and a best correlated interpretation map is selected from the numerous interpretation maps created.

Moreover, it has been found very useful to define as many “events” and states as possible. Then during learning, each event can be defined as the existence of a “state A” when it occurs. It should be contrasted by the signal interpretation engine against every other “non-state-A” events. This helps eliminate false positives, because many muscles, nerves, neurons, etc. may be affected by numerous events. It has proven very valuable to process data from all “state A” and compare them with all “not state A” data to find the best interpretation map.

The first computer is programmed with an iteration algorithm to execute the signal interpretation engine repeatedly to create a plurality of signal interpretation maps. It then applies a correlation executable effective to determine a best signal interpretation map of the plurality of signal interpretation maps. This may be repeated with data having a known event to verify its accuracy. Then the computer may receive operational data from the set of sensors in real time, and process it reliably, by using the best correlated interpretation may for every event. It is also programmed to send to the second computer instructions controlling the remote device based on the events occurring at the first set of sensors.

One embodiment of a method may include instrumenting a mammal with sensors providing electrical signals reflecting biological activity in the mammal. The sensors are selected to detect at least one of muscular activity, brain activity, neural activity, and dipole movement of a biological electrical dipole in the mammal such as eye movement, tongue movement, muscle contractions/extensions, or the like. A first data signal, comprising a first digital signal readable by a computer, is obtained by operating on the raw electrical signals by at least one of amplifying, converting from analog to digital, and filtering. Once sent to a computer, the signals are used by the computer (iteratively executing a signal interpretation engine) to create a plurality of signal interpretation maps (interpretation maps) by the computer iterating through a feature expansion process operating on the digital signal. The computer then selects the interpretation map having the best correlation for determine “state A” for an event, against all other conditions of “not state A” or “not A.”

Verification may be accomplished by testing each best interpretation map selected (from the plurality of signal interpretation maps) by using each map to classify a new digital signal independent from the first digital signal. The event condition and data are both known, and can be compared with the analysis by the interpretation map to verify that it is good enough to be the “best interpretation map,’ based on the greatest accuracy in correctly labeling the events.

Filtering may be selected from high pass filtering, low pass filtering, notch frequency filtering, band pass filtering, or the like. Filtering may be selected to isolate from one another at least two of muscular activity, brain activity, neural activity and biological electrical dipole activity by frequency distribution. The signals comprise a first inner signal having particular correspondence to a first event constituting a biological event of the mammal, the first inner signal being characterized by a frequency in the range of from about 1 to about 200 Hertz. Muscular signals tend to range from about 30 Hertz to about 100 Hertz, and typically 50-90 Hertz. Brain signals tend to run from about 1 to about 50 Hertz, and typically 3-30 Hertz.

Isolating the inner signal from the noisy signals is one reason for creating a signal interpretation map. This is done by by processing the first inner signal by feature expansion processing as described in detail in the references incorporated herein by reference. Selecting a signal interpretation map best correlating the first inner signal to the event enables receiving a second inner signal and classifying that second inner signal precisely. That second inner signal is manipulated according to the best interpretation map. Multiple interpretation maps are not used because they increase processing and do not provide a better outcome, identifying an occurrence of the event based on the classifying of the second inner signal.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a front perspective view of one embodiment of the system in accordance with the invention;

FIG. 2 is a rear perspective view thereof;

FIG. 3 is a side view thereof;

FIG. 4 is a process diagram illustrating the process of equipping a headset with sensors and electrodes effective to comfortably track and record muscular and brain activity of a user wearing a headset in accordance with the invention;

FIG. 5 is a schematic block diagram of a generalized computer for use in a headset electronics module, a computer associated therewith, or both, which may be a network enabled in certain contemplated embodiments;

FIG. 6 is a schematic block diagram of a process for recording biological events and using them in real time interpretation of events and output to a remote device controlled thereby;

FIG. 7 is a schematic block diagram summarizing the learning process by which to create an interpretation for use in a system and method in accordance with the invention;

FIG. 8 is a schematic block diagram of the process of interpretation map generation in summary;

FIG. 9 is a screenshot of a control panel for operating a system in accordance with the invention;

FIG. 10 is a screenshot illustrating various event identifiers equaling complex or combined event identifiers;

FIG. 11 is a chart illustrating various experimental data in actual operation of the system in accordance with the invention tracking activities of a user and processing the biological waves therefrom to control a device presenting an avatar replicating the activities of the human subject in the system;

FIG. 12 is an image of a user instrumented to detect motions of multiple bodily members as well as brain activity and nerve activity;

FIG. 13 is a screenshot of experimental data from an event resolution imaging (ERI);

FIG. 14 is a screenshot of experimental data from a visual study example;

FIG. 15 is a screenshot of experimental data from a touch study example; and

FIG. 16 is a screenshot of experimental data from a cognitive study example.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

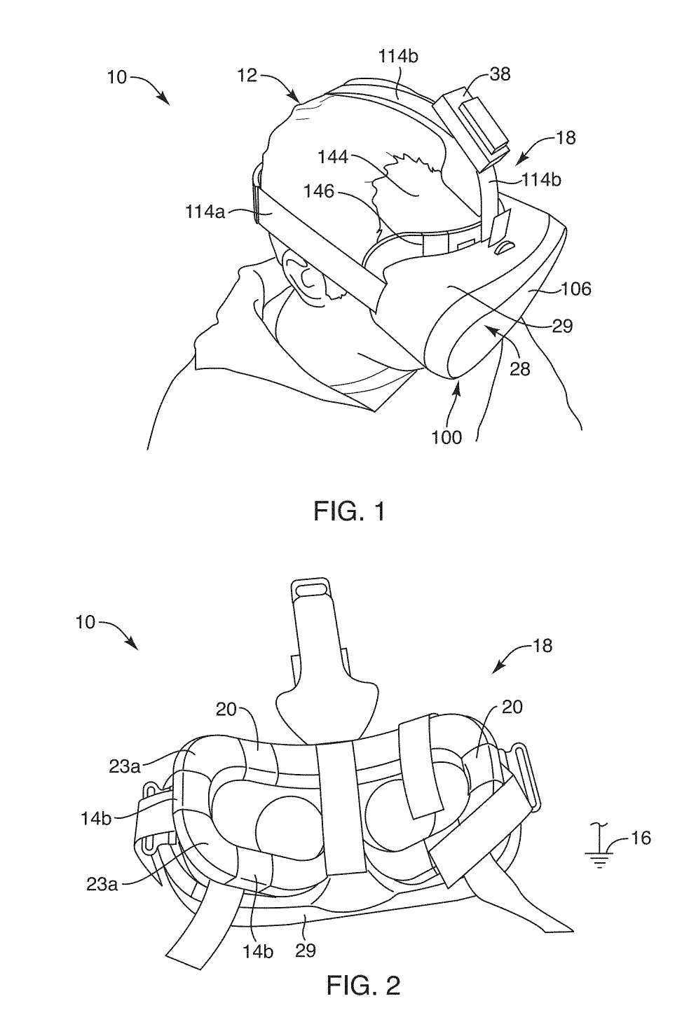

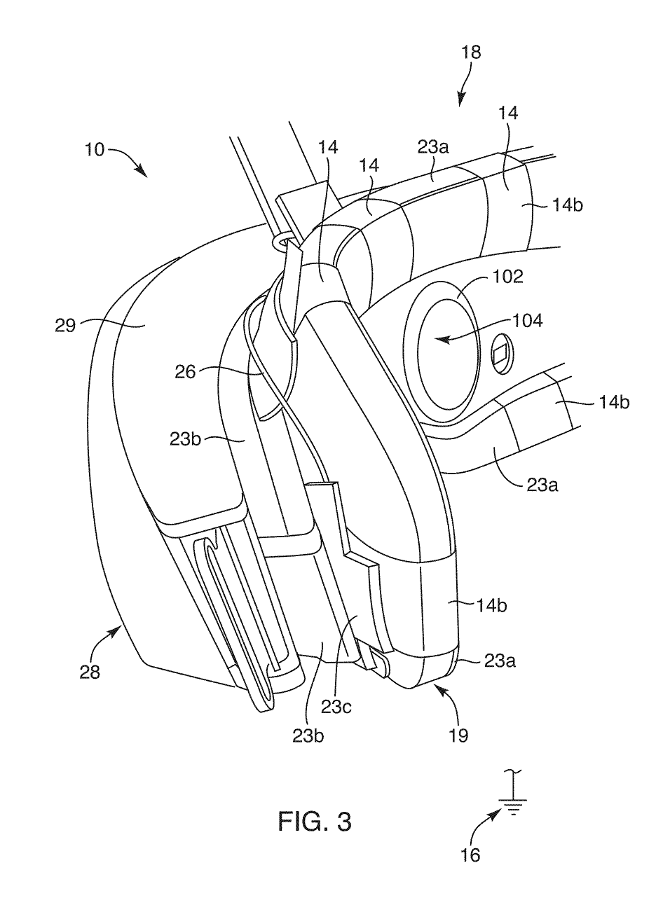

Referring to FIGS. 1 through 4, while continuing to refer generally to FIGS. 1 through 11, a system 10 in accordance with the invention may rely on a human subject 12. A subject 12 is fitted with sensors 14 that may be non-contact electromagnetic, or otherwise. In one embodiment, the sensors 14 may be electrodes 14 that may be detected by voltage, current, or both. Typically, sensors 14 may be distributed about a ground 16. In some embodiments, a sensor 14 may be a reference sensor 14a. Meanwhile, other sensors 14b may be detected with respect with either a reference sensor 14a, a ground sensor 14c, or both. Meanwhile, ground 16 represents a location that is grounded and may ground the sensor 14c at ground voltage.

In the illustrated embodiment, the suite of sensors 14 is arrayed within a headset 18. In the illustrated embodiment, a conductive fabric 20 is used to form each sensor 14. The conductive fabric is selected to be soft, flexible, highly conductive, and conformal to the skin of a user. In certain embodiments, the fabric 20 may be cut into strips of a selected size. In one embodiment, strips have a width of approximately half an inch to an inch wide. However, in other embodiments currently contemplated and implemented in prototypes, fabric 20 may be formed in much smaller strips, or individual pieces.

As a matter of user comfort, the fabric 20 may be formed such that the fabric 20 only connects to securements 21 such as glues 21, fasteners 21, or the like at locations remote or not close to the face on a subject 12. For example, a conductor 22 or foil 22 may be applied as a lug 22 or contact area 22 to a strip of fabric 20 opposite to the face of a subject 12.

For example, a pad 23 may be formed of an elastomeric foam material. In one contemplated embodiment, the pad 23 is formed of an elastomeric foam such as a synthetic elastomer that is an open-cell type in order to be easily deformed or deflected by the face of a user 12 in order to maintain comfort. Various stiffness's of material may be used to form the pad 23, in order to comfortably urge the fabric conductors 20 against the skin of a subject 12 to maintain electrical conductivity by the fabric 20. Meanwhile, the fabric 20 may contact or connect directly to connectors 24. In other embodiments, a conducting foil 22 may form a lug 22 or connection area 22.

Ultimately, leads 26 may be connected. For example, the lead 26a may connect a reference sensor 14a. A set or array of leads 26b may connect to the various other sensors 14b. Similarly, the lead 26c may connect to a round sensor 14c, and then to the ground 16, literally. That is, lead 26c may connect between the ground sensor 14c and the ground 16. On the ground 16, through the ground sensor 14c and the lead 26c may be used as a ground voltage of zero by a data logger accumulating data in the system 10.

An amplifier 32 receiving signals from the sensors 14 may be included with an analog-to-digital converter 34 along with a processor 36 in an electronics module 38. In some embodiments, the processor 36 may be an entire computer 40 capable of conducting learning, interpretation map creation, and operation of the system 10. In other embodiments, minimal processing 36 may be onboard the electronics module 38, with a maturity of heavy-duty processing being completed by the computing system 40.

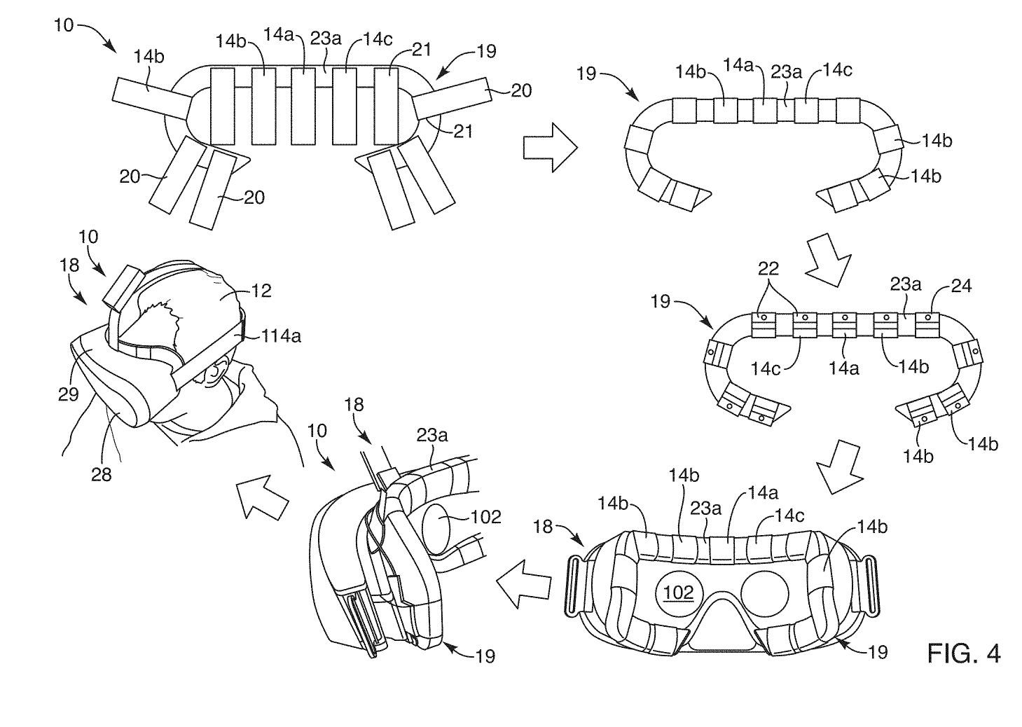

Referring to FIG. 4, while continuing to refer generally to FIGS. 1 through 11, the system 10 may be manufactured by placing fabric strips 20 on a front side (away from a face of a user 12), and securing fabric strips 20 thereto by any suitable connection, such as a glue, adhesive, or the like. This securement material 21 need not be conductive.

On the other hand, the strips of fabric 20 may be wrapped around the first layer of foam padding 23 in a headset 18. Thus, the rear or face side of the padding 23 or the first layer of padding 23 that is actually in contact with the face or other bodily member of a subject 12 has only free fabric 20 arranged as strips 20 and urged again into contact with a bodily member, such as a face of a user 12 by that padding 23.

Meanwhile, as illustrated, the front side, opposite the face contact side of the padding 23 may receive electrically conductive securement 21 or glue 21 or the like, to connect the two ends of the fabric strips 20 for a single strip thereon to itself. Thereafter, using a similar securement mechanism 21, optional conducting foil 22 may be added as a lug 22 to provide thorough connectivity between the fabric 20 and a connector 24. The conductor 22 is optional.

As a practical matter, a connector 24 may be any of a variety of electrical connector types. These may include clips, clamps, snaps, bayonet plugs, apertures and leads, spring-loaded electrodes clamping other springs, strips, wires, or the like. In the illustrated embodiment, beginning in the upper right and progressing clockwise, the strips of fabric 20 are first secured by some securement 21, such as a glue 21 to the front side away from the face of the padding 23. The fabric 20 is then wrapped around to completely circumnavigate the padding 23. The fabric 20 may then be glued to itself with a conductive securement 21.

Thereafter, a connector 24 may also be secured by any securement 21 that is conductive to assure a high level of conductivity, and very low electrical resistance between a lead 26 that will eventually be removably connected to the connector 24, and thus provide electrical access to the conductive fabric 20.

The next image illustrates the positioning of the padding 23 against other padding. For example, padding 23a may represent the layer of padding 23 closest to and in contact with a member (such as a face, arm, leg, etc.) of a subject 12. Beyond this padding layer 23a, may be a base padding layer 23b. This base layer may be more firm, and provides a conformation of shape between the user interface layer 23a and the display 28 or structure 28 that provides display for a subject 12.

An additional layer 23c has been found effective in some embodiments in order to assure that the edges of a headset 18 conform to the face of a subject 12. Thus, the wedge-shaped padding 23c may be placed near the right and left edges of the pads 23a, 23b in order to assure good contact between the edges of the face of a user 12, and the contact fabric 20 operating as sensors 14.

Ultimately, the headset 18 may be placed on the head of a user 12 as illustrated in the final image, with a display 28 mounted on a frame 29 to structurally stabilize the system 10 in operation on the head or other body member of a subject 12.

As a practical matter, sensors 14 may be formed of fabric 20 in order to contact any portion of the leg, such as a calf, ankle, foot, toe, thigh, or the like. Meanwhile, hands, forearms, fingers, upper arms, elbows, and the like may be fitted with sleeves that provide a certain amount of compressive force urging sensors 14 into contact therewith. In this way, any portion or a complete body of a subject 12 may be connected to a system 10 in accordance with the invention by a system of sensors 14 on a fitting 19 such as a headset 18, sleeve 19, or the like.

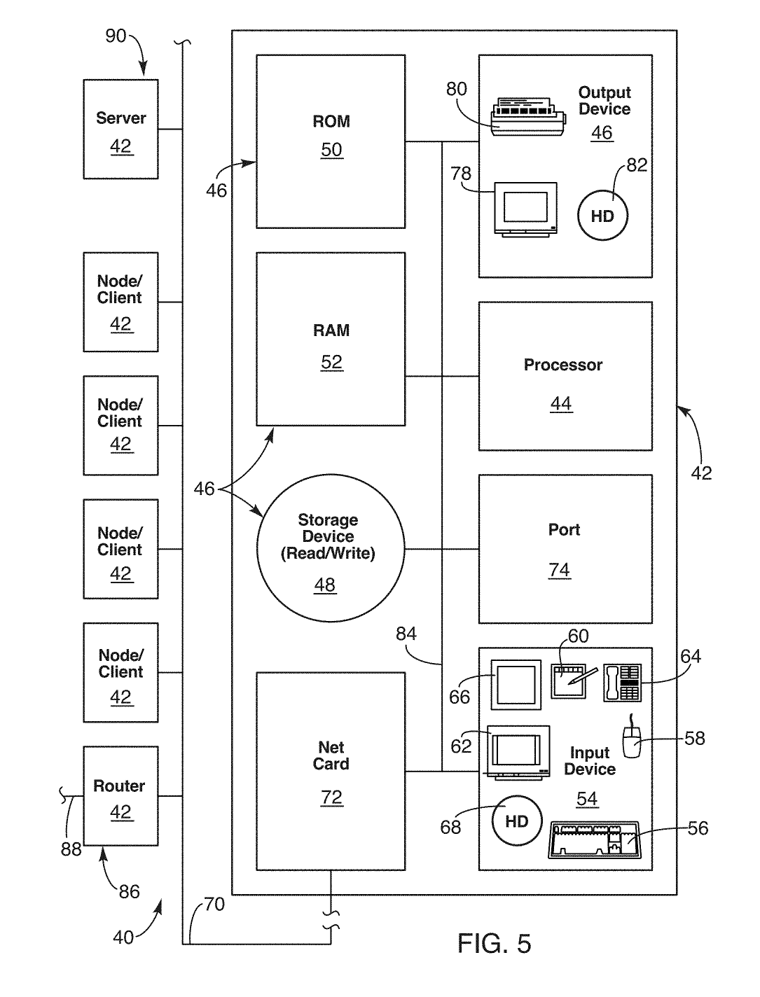

Referring to FIG. 5, an apparatus 40 or system 40 for implementing the present invention may include one or more nodes 42 (e.g., client 42, computer 42). Such nodes 42 may contain a processor 44 or CPU 44. The CPU 44 may be operably connected to a memory device 46. A memory device 46 may include one or more devices such as a hard drive 48 or other non-volatile storage device 48, a read-only memory 50 (ROM 50), and a random access (and usually volatile) memory 52 (RAM 52 or operational memory 52). Such components 44, 46, 48, 50, 52 may exist in a single node 42 or may exist in multiple nodes 42 remote from one another.

In selected embodiments, the apparatus 40 may include an input device 54 for receiving inputs from a user or from another device. Input devices 54 may include one or more physical embodiments. For example, a keyboard 56 may be used for interaction with the user, as may a mouse 58 or stylus pad 60. A touch screen 62, a telephone 64, or simply a telecommunications line 64, may be used for communication with other devices, with a user, or the like.

Similarly, a scanner 66 may be used to receive graphical inputs, which may or may not be translated to other formats. A hard drive 68 or other memory device 68 may be used as an input device whether resident within the particular node 42 or some other node 42 connected by a network 70. In selected embodiments, a network card 72 (interface card) or port 74 may be provided within a node 42 to facilitate communication through such a network 70.

In certain embodiments, an output device 76 may be provided within a node 42, or accessible within the apparatus 40. Output devices 76 may include one or more physical hardware units. For example, in general, a port 74 may be used to accept inputs into and send outputs from the node 42. Nevertheless, a monitor 78 may provide outputs to a user for feedback during a process, or for assisting two-way communication between the processor 44 and a user. A printer 80, a hard drive 82, or other device may be used for outputting information as output devices 76.

Internally, a bus 84, or plurality of buses 84, may operably interconnect the processor 44, memory devices 46, input devices 54, output devices 76, network card 72, and port 74. The bus 84 may be thought of as a data carrier. As such, the bus 84 may be embodied in numerous configurations. Wire, fiber optic line, wireless electromagnetic communications by visible light, infrared, and radio frequencies may likewise be implemented as appropriate for the bus 84 and the network 70.

In general, a network 70 to which a node 42 connects may, in turn, be connected through a router 86 to another network 88. In general, nodes 42 may be on the same network 70, adjoining networks (i.e., network 70 and neighboring network 88), or may be separated by multiple routers 86 and multiple networks as individual nodes 42 on an internetwork. The individual nodes 42 may have various communication capabilities. In certain embodiments, a minimum of logical capability may be available in any node 42. For example, each node 42 may contain a processor 44 with more or less of the other components described hereinabove.

A network 70 may include one or more servers 90. Servers 90 may be used to manage, store, communicate, transfer, access, update, and the like, any practical number of files, databases, or the like for other nodes 42 on a network 70. Typically, a server 90 may be accessed by all nodes 42 on a network 70. Nevertheless, other special functions, including communications, applications, directory services, and the like, may be implemented by an individual server 90 or multiple servers 90.

In general, a node 42 may need to communicate over a network 70 with a server 90, a router 86, or other nodes 42. Similarly, a node 42 may need to communicate over another neighboring network 88 in an internetwork connection with some remote node 42. Likewise, individual components may need to communicate data with one another. A communication link may exist, in general, between any pair of devices.

Referring to FIGS. 1 through 5, a headset 18 may provide a fitting 19 or fitting system 19 to place on a subject 12. In one embodiment, the headset 18 may be constituted as a mask 100 with associated frame 29 fitted by padding 23 to the face of a subject 12. In other embodiments, the fitting system 19 may be a sleeve 19 that may look like a medical brace or the like of elastomeric and fabric material urging padding 23 against the skin of a user 12 at any other bodily location appropriate for use of a system 10.

However, in the illustrated embodiments, the mask 100 operating as a significant portion of the headset 18 may include optics 102, such as lenses 102 in order to focus the sight of a subject 12 on a screen 104. The screen 104 may actually be provided by a smartphone 106. A smartphone 106 may include multiple images, such as a left and right image, each accessed by optics 102 appropriate to a left and right eye of a subject 12. Thus, a user 12 may have a screen 104 that is independent on a smartphone 106, or a smartphone 106 may provide this screen 104 to be viewed by a user 12 through the optics 102 of a mask 100.

A securement system 102 may include various straps 114. For example, a circumferential strap 114a may extend around the head of a user 12, such as near a crown or headband location of a conventional hat. Meanwhile, a vertical strap 114b may stabilize the circumferential strap 114a, as well as supporting the weight of an electronics module 38 thereof. In the illustrated embodiment, the straps 114 may also serve to stabilize the overall force applied by the padding 23 to the face of the subject 12.

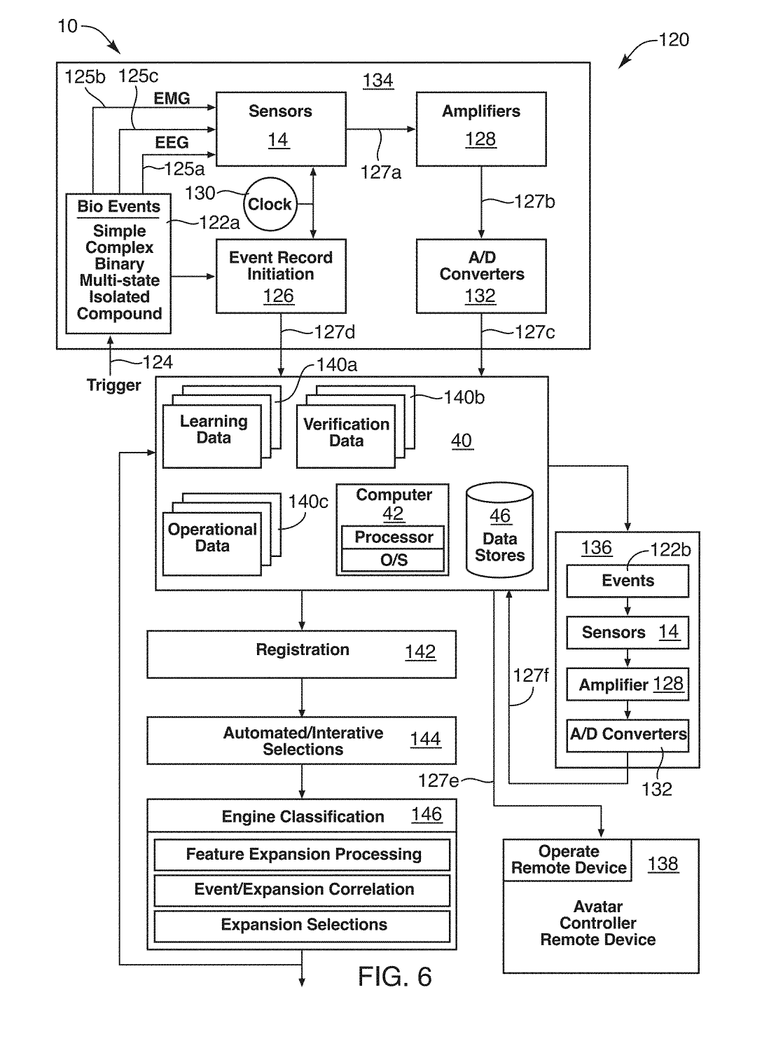

Referring to FIG. 6, while continuing to refer generally to FIGS. 1 through 11, a process 120 in accordance with the invention operating in a system 10 may rely on one of several events 122 occurring in a human body. As discussed hereinabove, an event 122 represents an activity that has electrical consequences.

Those electrical consequences may be detected on the skin of a user 12, in a non-contact sensor, through an electrode, through an electromagnetic detector, through an invasive internal probe, or by another mechanism. In general, an event 122 represents activity by a brain cell or group of cells, a neurological pathway, such as a nerve, nerve bundles, a neuro-muscular junction, or the like.

It has been determined that the signals provided through sensors 14 detecting an event 122 may be complex and still processed. It is a valuable discovery that signals need not be isolated. Of course, scientists, engineers, and mathematicians classically rely on isolating variables, data streams, and the like.

However, it has been found that in a system 10 in accordance with the invention, an event 122 may involve, muscles, nerves, the brain, and so forth. Accordingly, one objective is to simply observe an event 122, regardless of what all it may activate, actuate, or change. Accordingly, an event 122 may be identified in a way that renders distinguishable from other events.

For example, events may involve motions, such as extending a foot, extracting a foot, taking a step, lifting a foot, closing a hand or opening a hand, moving a finger (digit) on a hand or a foot, bending an elbow, bending a knee, lifting a leg, lifting a foot, tilting the head, raising eyebrows, raising a single eyebrow, smiling, smirking, winking, blinking, clenching teeth, opening or closing a mouth, and so forth. It has been discovered that events 122 are often recognized, in all their complexity, with sufficient precision by a human observer that each event 122 may be characterized with a name. For example, the foregoing events 122 provides an example, additional events 122 may be identified.

As a practical matter one will immediately see that these events 122 may be simple, such as a blink. Others may be complex, such as a teeth clench involving various muscular activity in the face, around the eyes, and within the mind. Similarly, some events 122 may be effectively binary, such that they may exist in one of two states.

This may apply for example, if a thumb is raised or lowered. This may also apply if a finger applies pressure, or releases pressure. This may also refer to an eye being opened or closed. In other situations, events may involve multiple states. For example, an event 122 that is multi-state in nature may involve various muscles throughout the face, as well as brain activity.

For example, in some embodiments of events 122 it has been found that a particular event may best be detected if juxtaposed against all other conditions and combinations thereof that are not and do not include such an event.

For example, in one embodiment, one may think of an event as a wink. A wink may be considered a state. However, one may determine that to distinguish a wink from all other states that are not a wink, one may test multiple states of various aspects of the face in order to compare signals. This is important to eliminate false positives. Similarly, in training particularly, events may be identified more easily if isolated.

For example, one may elect to perform an action in isolation, taking certain care to avoid involving any other actions Likewise, one may perform some action involving various facial elements, such as muscles, nerves, and the like together as a compound event. Again, one may take care to avoid involving any of the elements of that event 122 in establishing the multiple states that represent “not” that compound event.

For example, it has been found that a teeth clench facial movement as an event 122 is very complex, involves many muscles, involves brainwaves, and the like. It is difficult to isolate from other similar events. In contrast, a wink involves very few muscles in the face, and is a comparatively simple, isolated event, that may be tested in a more straightforward way.

Meanwhile, it has been found most effective to test not a binary, but a multistate distinction. Thus, in one embodiment, events 122 may be an identified, and their data collected as such an event 122. Then, taking care not to replicate or repeat that identified event, every other available activity may be undertaken in sequence and identified as a “not a” event. Thus, an “event A” may be distinguished from other “non A” events 122.

In the illustrated embodiment, an event 122 may result from a trigger 124. A trigger 124 may be any identifiable activity that may be followed by a subject 12 to initiate an event 122. The trigger 124 may be associated with or correspond to an electrical or electronic signal that is also sent to a sensor 14 in order to identify that the event 122 being recorded will surely follow.

In the illustrated embodiment, the events 122a may begin with a response to a signal from a trigger 124. A user 12, observing some outward signal initiated by a trigger 124 may then act to accomplish one of the events 122a. Sensors 14 may receive signals such as EEG signals 125a, EMG signals 125b or EOG signals 125c. Electrooculography refers to sensing eye motions. This may be done by muscles, nerves, or visual sighting, such as cameras. Accordingly, the sensors 14 may be selected to receive and sense EEG signals 125a perceived from the brain, EMG signals 125b perceived from muscles, and EOG signals 125c perceived from the eyes. Sensors 14 may then send their output signals 127a to an amplifier 128. Amplifiers 128 may be of high gain or low gain, high impedance or low impedance, and the like. It has been found useful to use comparatively high gain, amplifying systems signals 127a from about ten times to about one thousand times their initial magnitudes. A gain of about one hundred and more has been found suitable and necessary in many applications.

The amplifiers 128 on each of the channels of sensors 14, where each channel represents a single sensor 14 may be sent through a dedicated amplifier 128, or a multiplexed amplifier 128. Time division multiplexing, or code division multiplexing may be used to process high numbers of signals.

However, in certain prototypical systems in accordance with the invention, the number of sensors 14 in an experiment may be from about four to about 32 sensors on a single appliance such as a mask 100 or headset 18 worn by a subject 12. These amplifiers 128 may be dedicated each to a single channel attached to the headset 18. Meanwhile, analog-to-digital converters 132 may take each of the signals and convert them into a format more readily and by a computer system 40. In fact, A/DCs 132 may include additional processing, typically to normalize signals. For example, the outputs 127b from the amplifier 128 may be processed before being passed into the converters 132.

However, at some point prior to passing a signal 127c to a computer system 40, it is helpful to normalize a signal by dividing it by some probable or maximum or impossible maximum. In this way, the values of the signals 127c received by a computer 40 will always range from a number value of zero and one. That is, by normalizing a signal 127c, dividing its value by the maximum permitted or expected value, the signal 127c condition is best if always normalized to a value between zero and one, 100, or some normative maximum.

Continuing to refer to FIG. 6, a record initiation 126 may occur as a direct consequence of an event 122a. Accordingly, that event record may output the signal 127d to the computer system 40 in order to associate a timestamp on the event record initiation 126 to the signal 127c corresponding to the particular event identified by that initiation 126.

Typically, the sensors 14 and the record initiation element 126 will read from the same clock 130. That clock 130 may be part of the computer system 40. In other embodiments, the sensors 14 may have associated therewith their own microprocessor having a clock 130. Similarly, the event record initiation element 126 may also be a part or a programmed element of such a microprocessor. Thus, in general, a process 120 or system 120 in accordance with the invention may include and represent, as in this diagram, both hardware and software, as well as steps in a process 120.

In general, processing of the signals 127c by the computer system 40 may involve registration 142 of signals 127c. For example, following a trigger 124, a timestamp is associated with a record.

In a learning configuration 134 the event record initiation 126 is important in order to correspond the signal 127c to a timestamp from the clock 130, and the initiation signal 127d. At a later point in the process 120, registration 142 may involve aligning a timestamp and a signal 127d, with a timestamp in a signal 127c. The actual data representing an event 122a whose data is represented in the signal 127c may be identified more precisely as to its beginning and ending time. One mechanism for registration 142 is to intentionally render an event 122a to move from a non-existent state at the beginning of a data record 140a and then progress to an activated or different state at a later point. This is typically somewhere within a central portion of the data file or stream that represents the data record 140a.

Thereafter, as the event 122a signals reverses or winds down, comes to a close, the condition returns back to its initial inactive or inactivated state. Thus, the data record 140a for a particular event 122a may progress from a non-active condition, to a maximum and held condition, and then transition back to the non-existing condition. Registration 142 may actually occur by measuring the maximum value of a signal 127c, and selecting a time period over which that signal is within some fraction, such as within ninety percent or eighty percent of that maximum value. This establishes a value and a duration in which an event 122a has been held in its activated condition.

Thereafter, the registration process 142 may measure or calculate the time outside of the activating condition both following, and preceding the maximum activation value at which the signal drops off to approximately zero effective signal. In this way, data may actually be registered as to its maximum signal value, the duration of the maximum signal value, a duration of signal within a certain percentage or fraction of the maximum value of the signal, as well as the transition periods preceding and following ascent to that maximum value.

As a reality check, registration 142 may actually take place after some initial signal processing to filter out noise. In other embodiments, registration 142 may simply select the timestamp, and process the entire duration of signal 127c in a particular record 140a. Thereafter, a more precise registration 142 may be done after the automated and iterative selection process 144, and the engine classification process 146.

In a system 10 in accordance with the invention, it has been found useful to execute a classification process 146 repeatedly. In fact, it has been found useful to march through all learning data 140a one segment at a time. Segments may be broken up into any time found useful.

For example, in one embodiment, it has been found useful to record and event 122a having a total time of recordation of from about half a second to several seconds. Many times, events may occur within a period of about two or three seconds. Thus, an entire record 140a, 140b, 140c may correspond to an event 122a over a period over about two or three seconds. That overall event 122a may be recorded in a record 140a reflecting a signal 127c.

The automated and iterative selection process 144 then marches through the entire time duration of a record 140a in pieces. For example, these may be from about ten to about one hundred fifty milliseconds each. In one currently contemplated embodiment, each segment of time selected for evaluating the signal 137c recorded in a record 140a may be about one hundred twenty eight milliseconds long. Each segment may simply advance a mere ten, twenty, thirty, or fifty milliseconds forward from the previous.

Thus, the segments of signals 127a may actually overlap one another. In other words, a large sample of data covering 128 milliseconds may begin immediately or after some delay from the point of the timestamp provided by the signal 127d. It may then advance by ten, twenty, thirty, or more milliseconds to a new time segment, also occupying a total duration of 128 milliseconds. Thus, the individual samples or segments may march through taking samples from an overall record 140a corresponding to the total elapsed time of a particular event 122a.

Another part of the automated and iterative selections 144 may involve operating the classification engine 146. The details of the entire classification engine 146 are not repeated here. The classification engine 146 is described in great detail of the materials incorporated hereinabove by reference. However, in a system and method in accordance with the present invention, the classification engine 146 may be operated on each segment of each record 140a of each event 122a reflecting the signals 127c.

Out of the classification engine 146 come numerous signal interpretation maps. As part of the automated and iterative selection 144, those maps are then correlated with the event 122a. Again, correlation involves any of numerous available “numerical methods” as that term is known in the mathematical and engineering arts.

Numerical methods are a class of computational methods that rely on numerical approximations to functional relationships that may or may not be definable. Accordingly, numerical methods are used in accordance with mathematical approximation theory to provide convergent solutions to insoluble mathematical equations. Thus, given a delta (some small limit) one may find an epsilon (some bounded value) within which one may compute and still be within the required delta of the actual, but not explicitly known, value of the undefined or insoluble function.

Again, numerical methods fills volumes of textbooks and reference books. Accordingly, to describe them all is beyond the scope of this document. However, the terms used herein are understood in the art of numerical methods as solution techniques. Accordingly, terms like Runge-Kutta, Norton's method, the method of steepest descent, shooting methods, predictor-corrector methods, least squares fit, and the like may be used to solve approximately or to estimate approximately with any desired degree of accuracy a curve, a correlation, or the like.

Meanwhile, numerous statistical methods exist for correlating numbers or functions or values, or the like with each other with some degree or percentage of certainty. Thus, one may say that with ninety five percent certainty, or at ninety five percent accuracy, some value represents a correlation between two mathematical things.

Accordingly, in the automated iterative selection process 144, the classification engine 146 conducts feature expansion processing, feature expansion, and a correlation, and eventually selects an expansion technique for processing signals 127c. Accordingly, correlations will show which interpretation maps output by the classification engine 146 best match the “event A” or the condition A for an event.

In a system and method in accordance with the invention, all events 122a that are not event A or condition A of event A may be processed as well, and identified as “not A.” In this way, a best correlating signal interpretation map may be selected as the signal interpretation map that will ultimately be used in a process 136 identified as an operational configuration 136.

The operational configuration 136 again passes through events 122b, in which sensors 14 detect conditions that are forwarded as sensors 14 detect signals 125a, 125b, 125c, or the like, and output those as signals 127a, which are typically voltages, currents, or the like. Those signals 127a are then amplified by amplifiers 128 to be output as signal 127b into A/DCs 132 that will eventually output signals 127c to the computer system 40 to be saved as verification data 140b or operational data 140c.

The difference between verification data 140b and operational data 140c is that the actual event conditions, referred to hereinabove as “condition A” and “not condition A,” meaning all other conditions that do not include a conditional A within them, are known. Thus, the verification data 140b is much like the learning data 140a. The events 122b are known, and the system 10 is engaged to classify those events 122b. Eventually, those classifications are compared with the known conditions of the events 122b. If the classifications are accurate, then the signal interpretation map is considered adequate. Thereafter, the operational process 136 may operate online in real time to take operational data 140c from actual events 122b, that are not known, and classify those events 122b as actual data. In this way, a wearer 12 or user 12 can simply perform or behave while operating a game or remote device 138. The remote device 138 may be a computer hosting an avatar. The device 138 may be a controller controlling any device that is mechanically configured to permit electronic control of its activities.

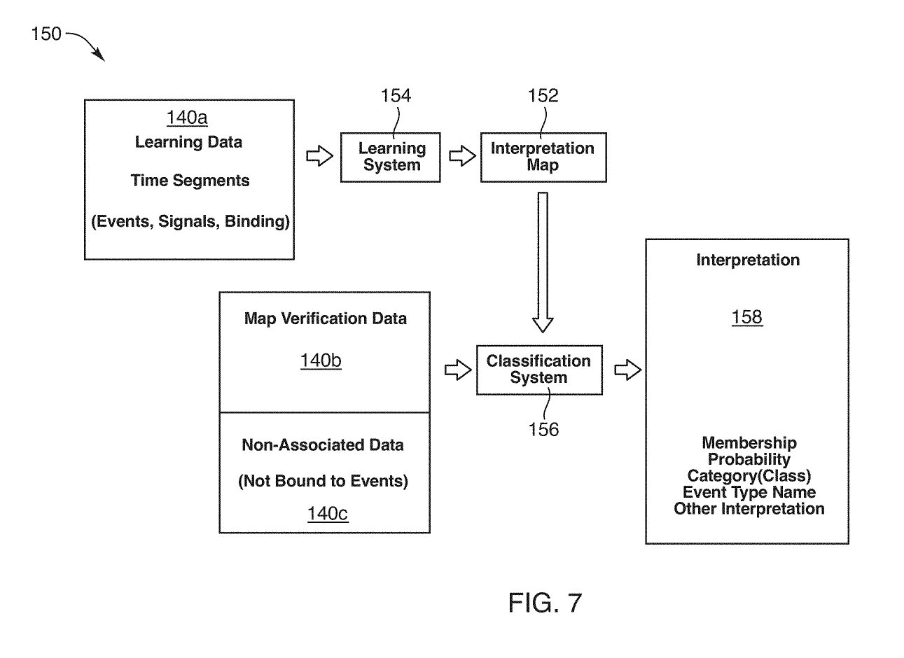

Referring to FIG. 7, while continuing to refer generally to FIGS. 1 through 11, a process 150 may proceed according to the following algorithm or methodology. Learning data 140a is received as the signals 127c becoming learning data 140a stored in a computer 42, such as in a data storage 46. The learning data 140a is broken into time segments. Accordingly, events 122a have been recorded, through their signals 125 that eventually become the outputs 127 recorded in the records 140a. Each includes an identification of event 122a, the signals 127c or their physical electronic representations, with the binding therebetween.

The learning system 154 operates in accordance with the references described hereinabove and incorporated hereinabove by reference to produce interpretation maps 152. The classification system 156 then takes map verification data 140b and classifies it by applying an interpretation map 158. Again, the interpretation process 158 uses an interpretation map in order to identify membership in a category or class and a probability that a particular event 122b detected is a member of that class or category. An event 122b will have a type or name and may include other interpretations, such as a degree of a condition. Thereafter, the non-associated data 140c or operational data 140c that is not bound to any particular event may be streamed into the classification system 156 using the signal interpretation map previously developed by the engine classification system 146 and the vast interpretation map available to provide an interpretation 158.

A signal 127d is processed by the computing system 40 in order to return a control signal 127e to operate a remote device 138. Again, any remote device will do. Anything from an engine, to a computer controller, to a mechanical device, image controller, servo-controls, or the like may be controlled in accordance with activities of a series of events 122b corresponding to a wearer 12.

Think of a robot or electro-mechanical device, remote from a user 12 or subject 12, that operates in accordance with the actions of a wearer 12 of sensors 14 in a suite, a combination of sets 18, such as headsets 18 or arm bands, leg bands, gloves, shoes, etc. Ultimately, the destination of the control signals 127e is selectable by a person or organization.

For example, the signals may simply activate an avatar, a computer-generated image. That computer-generated image may be a face or full body. Similarly, a robotic animal may operate as a remote device 138 industrial machine, process, or robot to be controlled by a human wearer 12 of set 18 of sensors 14 in order to replicate the actions of an animal. Similarly, an actual animal may be provided with sensors 14 in order to replicate a digitally animated animal on a screen 104 of a system 10.

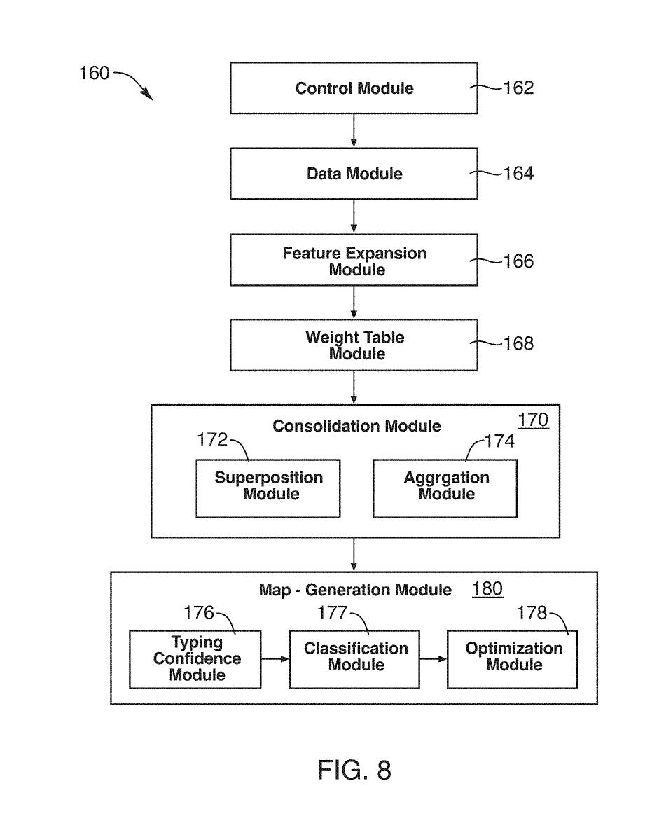

Referring to FIG. 8, the summary illustrated in the process 160 is detailed in the reference materials incorporated hereinabove by reference. As illustrated, a control module 162 provides outputs to a data module 164 which in turn provides data to a feature expansion module 166. This information combined with weight tables, or weighting in a weight table module 168 may be provided to a consolidation module 170. This may provide both super position 172 and aggregation 174. Ultimately then map generation 180 may include typing confidence 176, classification 177, and optimization 178. Again, discussing all the details of these is not required at this point because they represent systems in use in a method and apparatus in accordance with the current invention.

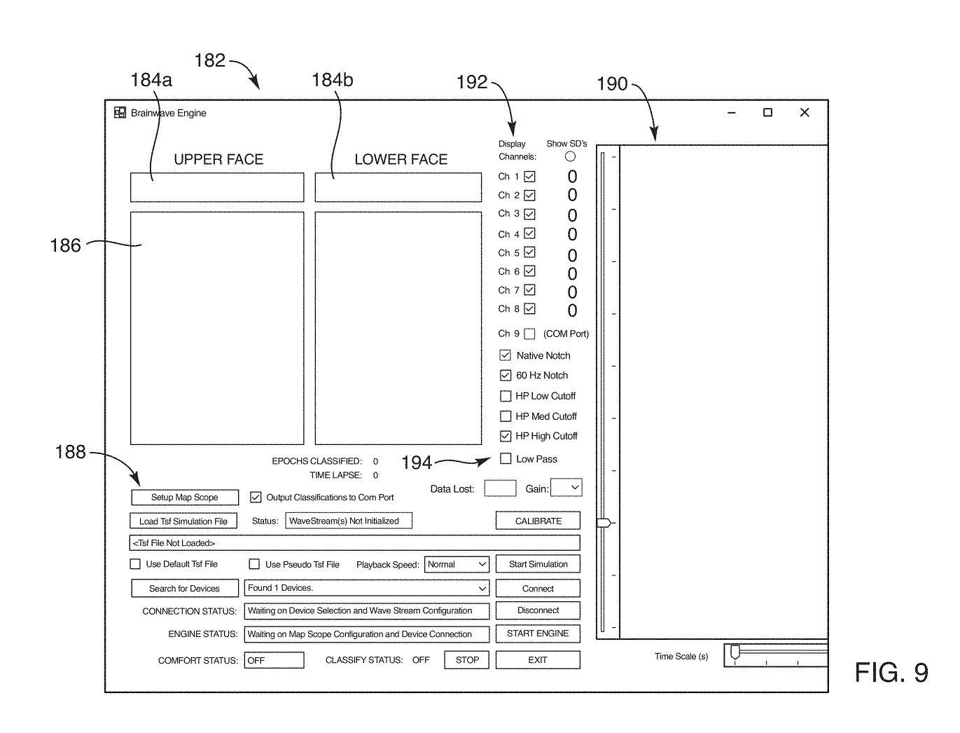

Referring to FIG. 9, a control panel on a computer screen or other screen 104 is shown.

This may include fields 184a, 184b for portions of a bodily member or region being recorded. Similarly, panels 186 display classification of epics or time periods corresponding to events 122. Various control buttons 188 may provide for set up, loading of files, identification of files by name, devices, and the status, such as whether or not a device is physically or electromechanically connected, or even electronically connected over a network.

Similarly, the classification engine 146 or other electronic engines and modules may be identified as to their status. Again, communication ports, classification status, and the like may be reported. Channels may be selected, and have been demonstrated. Channels may include any number, all of which any subset may be selected for observation.

Meanwhile, the channels selected will output their data on a screen 190 or display 190 as charts showing signals 127e. During learning, the signals 127c from record 140a may be displayed on the screen 190. During verification, the verification data 140b may be displayed. In particular, operational data 140c may be displayed on the screen 190 by channel. To the extent desired, one may display either the data 127c, which is comparatively raw, or the data 127d that has been processed.

One may select the filters 194 through which a signal 127f may pass. 127d has been used above for two signals, most of the 127d's need to be changed to 127f's. 127d comes from the box 126. 127f comes from the box 136. In the illustrated embodiment, a subject 12a is controlling an object or device 196a. Accordingly, an operation 200 illustrates various state outputs 202. In fact, the state outputs 202a through 202h represent various states, charts, or devices. Accordingly, in each event a user 12 provides signals 125 that are processed and illustrated as data 204. In fact the data graphs 204a through 204h represent different states, 202a through 202h corresponding thereto.

Accordingly, as a subject 12 changes the state 202 of the face of the subject 12 from the condition illustrated by the subject 12b , 12c, 12d, 12e, 12f, 12g, 12h, and so forth, the signals 127 corresponding to the charts 204 or graphs 204 are created. These exist for monitoring purposes. They are somewhat informative, although not typically interpretable directly by a user 12.

In accordance with the signals 127 proceeding from the graphs 204, the controlled devices 206a through 206h are controlled thereby. In this case, the controlled device 206 is a monitor 196 or screen 196 illustrating an avatar control in accordance with the actions of the subject 12. In accordance with the charts 202 and the devices 206g, representing the avatars, one will see that a neutral facial expression, a smile, an eyebrow up, eye blink, left wink, left smirk, right or left wink or smirk, or a combination thereof, a smile with brow up or down, mouth open or closed, the brow alone moving up or down, and the like may all be seen.

As a practical matter, it has been found that certain facial expressions involve more muscles and therefore more data. In the illustrated embodiment, for example, a teeth clench was found to involve many more muscles, and be a much more complex signal. Accordingly, it was much more difficult to separate out from other signals.

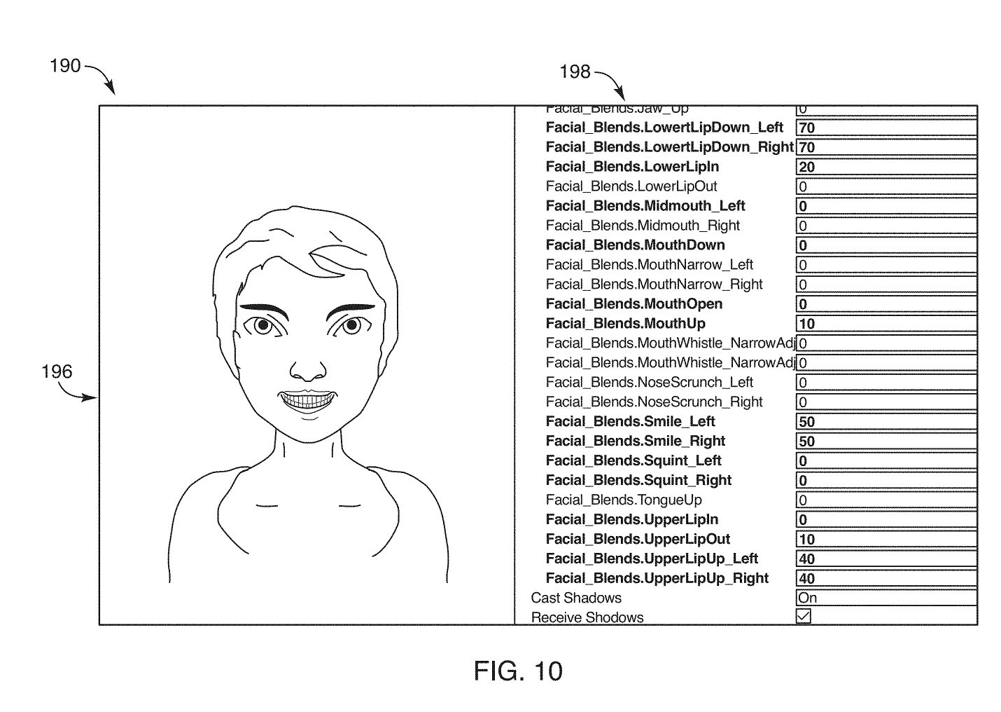

Referring to FIG. 10, while continuing to refer generally to FIGS. 1 through 11, in one embodiment, a screen 190 illustrates an image 196 along with various states 198. The states 198 or event sources 198 may be identified in terms that are intelligible or understandable by a user 12. For example, this illustration shows various facial blends of actions including a lower lip down left, a lower lip down right, a lower lip in, a lower lip out, and so forth.

A smile may be identified as illustrated here, being either right, left, or both. Similarly, a nose scrunch, sometimes referred to in literature as “wrinkling ones nose,” may be identified. Similarly, a mouth being opened, closed, in a whistling open, or a larger or more gaping open, or the like may all be identified, and have been. Thus, one may see the output of the signals 127e where the remote device 138 is a screen avatar and its associated event source identifications output by the system 10.

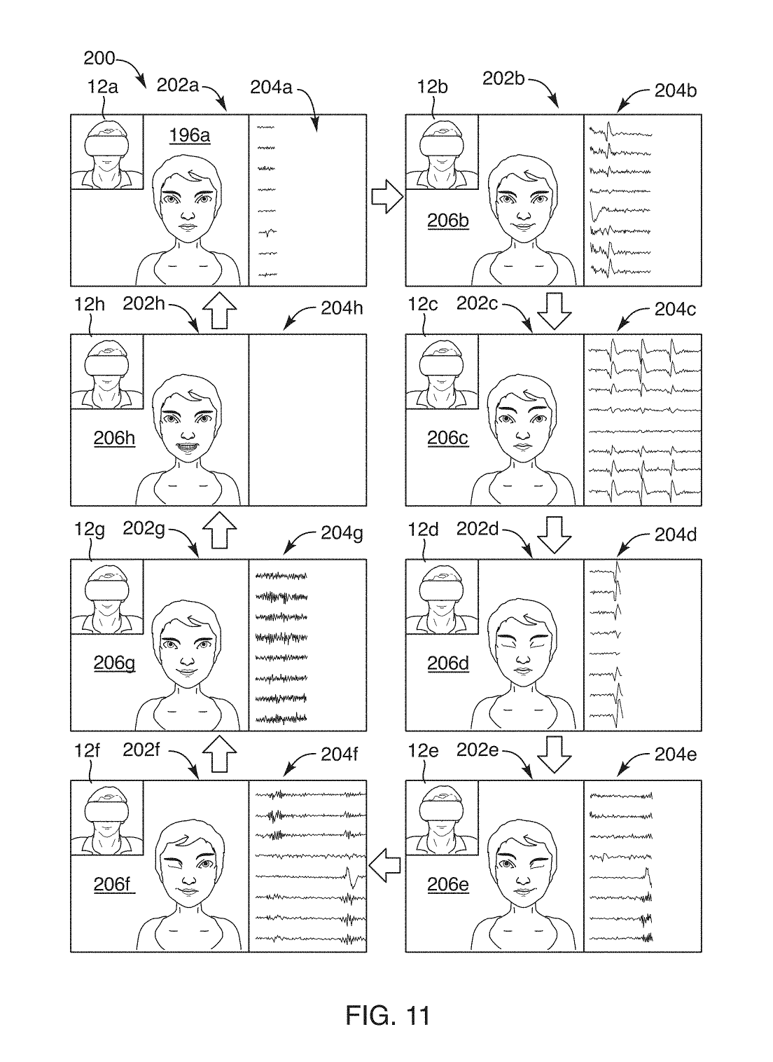

Referring to FIG. 11, while to continue to refer generally to FIGS. 1 through 11, certain experimental embodiments are illustrated. In the illustrated embodiments, various events 122 were created by a subject 12. The signals were processed, then provided as controls to a computer generated avatar. This demonstrates direct control of a remote device by a human subject 12 wearing sensors 14.

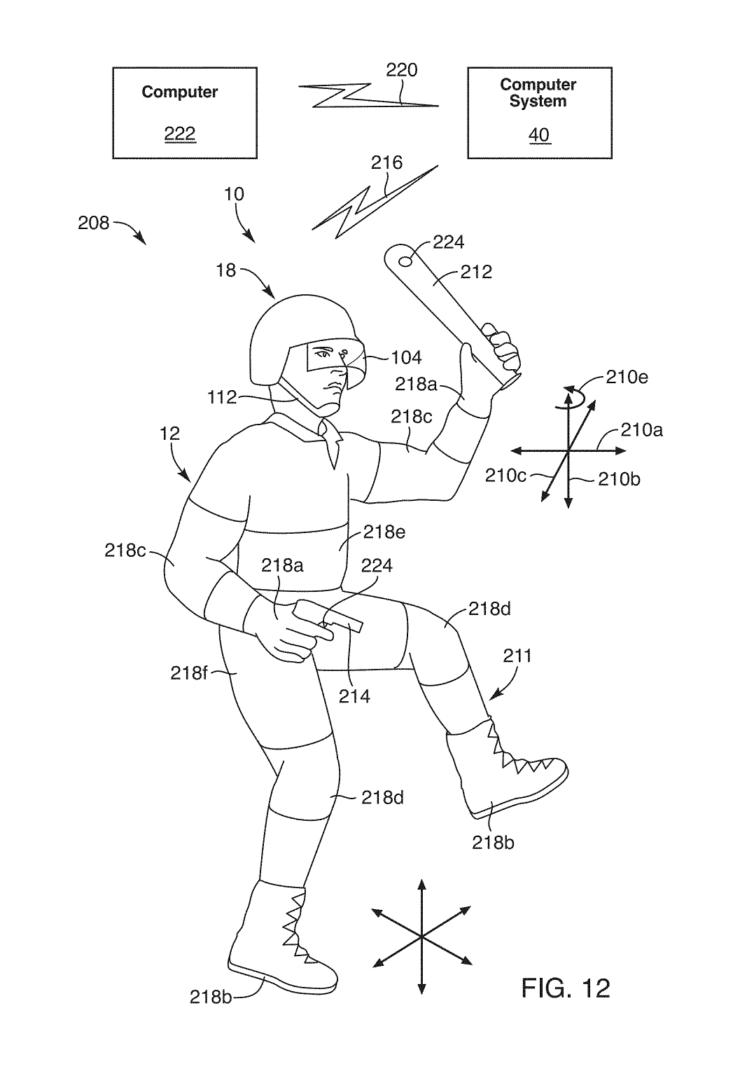

Referring to FIG. 12, a virtual reality system 208 may involve a subject 12 equipped with a headset 18 of a system 10 in accordance with the invention. In the illustrated embodiment, various elements are illustrated. For example, the individual user 12 or subject 12 may be dressed with clothing that is instrumented, and be free to move within an environment 208 in any direction 210.

For example, forward and back directions along an axis 210a, the up and down directions along an axis 210b, or movement right and left along an axis 210c may all be accommodated. In addition, movement in any circumferential direction 210e may occur about any of the axes 210a, 210b, 210c. In the illustrated embodiment, a user 12 may be using a bodily member as either motion, weapon, or the like, that bodily member 211 may be any portion of the body of the subject 12.

A user 12 or subject 12 may wield an inactive article 212. An inactive article 212 may be a sword, a bo (cudgel), nun chucks, knife, or the like. This inactive article 212 may be instrumented, or not. If instrumented, then the inactive article 212 may provide spatial identification of itself within the virtual reality environment 208. For example, it may have sensors that are detected by light, motion, or other types of sensors. Meanwhile, the inactive article 212 may actually have electronics on board, or be detectable by electronics associated with a nearby computer system 40 associated with the environment 208.

Similarly, the user 12 may hold other articles, such as active articles 214. Active articles 214 may be such things as guns, bows, launchers, or the like. An active article 214 may be thought of as something that typically launches a projectile or effect, and thereby affects (in the virtual environment 208) an area beyond its own envelope (occupied space). For example, a gun as an active article 214 may be aimed, and will shoot, not really or literally, but virtually, a projectile along a direction. Such a projectile may be replaced with a beam showing from the active article 214, such as a barrel of a gun, the tube of a launcher, or the like.

In a system 10 in accordance with the invention, the user 12 or subject 12 may be provided with a system of sensors 218 or sensor sets 218. These sensors 218 may be manufactured as discussed hereinabove. The sensor sets 218 may contact the skin, to detect both EMG data and EEG data. The brain itself will not typically be detectable by a sensor sent 218a in a glove embodiment 218a, nor a boot sensor set 218b. However, nerve junctions, various neural pathways, and the like may still be detected by contact sensors, or non-contact sensors contained in the various sensor sets 218.

In this regard, a suit worn by a user 12 may include various sensor sets 218. For example, a sensor set 218 may be an elbow sleeve 218c extending from a forearm through an elbow region and onto an upper arm. Similarly, a knee or leg set 218d may extend from a calf through a knee, to a thigh. Similarly, a torso set 218e may cover any portion of a torso of a user 12. Likewise, a trunk set 218f may include an abdomen and upper thigh area, subject to significant motion.

In a system 10 in accordance with the invention, cameras or other targets on any of the sensor sets 218, or any of the inactive articles 212 or active articles 214 may be used. Even light emitting elements may be connected on the inactive articles 212 or active articles 214. However, that is not the principal point here. Here, the sensor sets 218 operate just as the headset 18, such as with its conducting fabric 20 backed by padding 23 in order to assure contact between the fabric 20 and the skin of a user 12. Again, by processing signals in accordance with the invention, the myographic data and the electroencephalographic data tell the computer system 40 through the headset 18, and the other sensor sets 218 where the subject 12 intends to move, and where the subject 12 has moved.

The earliest indicator of motions of a subject 12 will be reported by encephalographic sensors 14 in the headset 18. Meanwhile, at neuromuscular junctions, the neurological signals may be detected by the sensor sets 218, as discussed hereinabove. Thus, a subject 12 may engage in virtual activities, including fisticuff, wheeling of inactive articles 212 or active articles 214, in response to views of images generated virtually on the screen 104 of the headset 18.

In such a virtual reality system 208, a link 216, such as a wireless link 216 may communicate between the headset 18 and a nearby computer system 40 as discussed hereinabove. The benefit of this is that subject 12 need not be encumbered by the limiting presence of wires extending from any of the sensor sets 18, 218 communicating with a computer system 40 present for doing additional intensive processing.

The user 12 may game against others in the virtual environment 208 through an internetwork 220, such as the internet communicating with a remote computer 222 corresponding to the computer 40, but applying to a different user elsewhere. To the extent that encephalographic data may be relied upon, signals will be much faster, and much more quickly available than those that rely on EMG data. Moreover, either of these is available much more quickly than sensed data from targets 224 that may be placed on the articles 212, 214.

The use of cameras, although possible as a hybridization of a virtual reality system 208 are possible, but unnecessary. Here, the combination of encephalographic (brainwaves, neurowaves) data and electromyographic (muscle waves or signals) do not require as much processing after the learning period as would cameras. Cameras rely on so much image recognition processing that the ability to track movements of a subject 12 would be much slower, require much more processing, bigger computers, including remote computers 40 separate from the headset 18.

In a system and method in accordance with the invention, Applicant has progressed beyond the prior art concept of binary state classifications to multi-state. In the system illustrated, a particular condition or “state A” was defined. This condition or “state A” was then compared and tested against all conditions that did not include state A, and thus all identified conditions that were “not A.” This provided much improved accuracy. In prior art systems, false positives have been always problematic. In a system in accordance with the present invention, precision was provided that was greatly improved, and typically was completely accurate in controlling a remote device 206 by the events 122 generated by a subject 12.

Likewise, in a system in accordance with the invention, mixed EMG, EEG, and EOG signals are and may be processed simultaneously, as a single signal. In other embodiments, exercised in a system and method in accordance with the invention, filters, such as high pass filters, low pass filters, and the like have selected according to preferred ranges of frequency to separate out events recorded in a single data stream 127 output by a system 120 in accordance with the invention.

A particular benefit has been the development of comfortable sensors 14. These sensors 14 may be wet or dry, but have been found completely adequate as dry sensors. This stands in contrast to prior art systems which typically require comparatively invasive, even painful, penetrations, whether or not the skin is broken by sensors 14. It has been found that one may apply sensors 14 to record EMG and EEG signals simultaneously from particular location.

In other embodiments, it has been found placing the sensors 14 at locations closer to neuromuscular junctions provides enhanced neurological signals. Meanwhile, pure EMG and EEG data have been found to be somewhat offset (out of phase) from each other. For example, EMG data is somewhat delayed, inasmuch the EEG data represents the thoughts controlling the mechanical actions recorded in EMG data corresponding to events. Thus, to correlate EEG data with EMG data in accordance with the invention, it has been possible to process and filter data in order to register EEG data with the EMG data for closer correlation that accommodates the time delay therebetween.

It has been a further advance to automate feature expansion in order to be able to do real time analysis of signals 127 output from an event 122. By choosing only a single, best, signal interpretation map, processing is very fast, and classification engine 146 may quickly identify a condition representing an event 122.

In certain embodiments, it has been found useful to divide one portion of a bodily region or bodily member from another. For example, in the illustrations above, the upper face and lower face may be processed individually. In complex signals, or complex events 122, certain activities may give false positives for other activities that are somewhat different, but which effect muscles similarly.

It has been found important to consider the order in which classifications are processed. For example, teeth clench has been found to create overwhelming signals 125, 127. In a teeth clench mode, so many other events are implicated to some extent or another, that all other events may be ignored in the presence in such a data avalanche.

Meanwhile, the latency between one gesture and another after an event 122 has been found to be useful in processing and classifying events. The classification engine 146 may actually detect from brainwaves events sooner than from muscle waves. Similarly, certain events 122, such as a smile may be captured with the first hint. Accordingly, in one process, the transitions move from a non-A condition to an A condition over some well-known and mapped time period.

Accordingly, it is possible to then reduce the amount of data that is required when such an event 122 occurs, and transition into generating the event 122 as an output on the remote device 138. Similarly, other gestures that cause events 122, such as the brows typically require a longer hold for training, notwithstanding they may be detected live with a comparatively shorter sampling time. These are all new developments incorporated in a system in accordance with the invention.

A library of time and frequency settings has been created. For example, EMG data tends to occur at higher frequencies than EEG data. Thus, higher frequencies indicate sources, and therefore events 122 according to those sources. Likewise, frequencies of signals 125 may range from about ten Hertz (cycles per second) up to about ninety Hertz, and above may be recorded usefully. The brainwaves may often be down as low as three Hertz. Thus, brainwaves may typically be isolated from the signals 125 by subsequent signal processing, and thus output signals 127 that are in a lower frequency range. Meanwhile, a low pass filter may isolate electromyographic signals 125b.

It has been found best to select about three to five frequencies with each of the iterations 144 to be processed by the classification engine 146. Then it has been found useful to run up to 200 iterations or different settings. Accordingly, the classification engine may then process to create multiple signal interpretation maps. It has also been useful to evaluate the data in order to determine latency of a signal, as well as what frequencies are used and picked out of the data stream 127 to be processed by the classification engine 146.

Likewise, some events 122 have been found to be dependent or to occur longer period of time. Others are found to be more discrete. For example, a smile has been found to have a start portion, a hold portion, and a release. Even if the transitions are inaccurate or ignored, the signal interpretation engine 146 will typically be able to detect a smile, including initiation, a hold, and a release.

Each library may contain files of parameters, representing numbers to pick. First, frequencies to be tried over an entire event 122. Similarly, latency or the time period between initiation of an event 122 and certain aspects of the signal 125 occurring may be important.

Similarly on recording data, in learning mode 134, it is possible to key in, trigger, timestamp, or otherwise obtain an exact start. In later operational mode 136, the classification engine 146 must detect events 122 according to their leading or header information. Thus, processing the header or transition period changing from a non-state-A condition to a state-A condition or beginning it become much more important for the classification engine 146 to detect.

Again, importantly it is very important to test many events 122 in order to clearly distinguish between an “A condition” and a “not-A condition.” Thus, rather than the prior art systems of binary events 122 and their detection in binary signals 125, it has been necessary to process data differently, and more of it, in order to avoid false positives.

Applicants have identified multiple use cases and methodologies for brainwave virtual reality systems. These include brainwave virtual reality systems for:

1) Surface Facial Expressions & Emotions for Human Avatars,

2) Deep-Brain Human Feelings of Frontal Lobe & Limbic System.

3) Thought to Speech Engine for Silent Human Communications,

4) Thought to Action Engine for Animating Human Avatars,

5) Peak Performance Sports Training for the Human Brain & Body,

6) Personal Brain Health & Fitness and Human Wellness Training,

7) Human Brain Meditation Guidance with Light & Sound,

8) Neurofeedback Training & Brainwave Biofeedback Therapy,

9) Light, Sound, & Video Therapies & Entertainment,

10) Brain-Monitored Education & Learning in School & Beyond,

11) Social Human Avatar Dating in Virtual World Environments,

12) Social Media for BVR Immersive Human Connections,

13) Facial Muscle Relaxation Training,

14) Personal Human Smile Training,

15) Personal Human Facial Beauty Awareness & Beautification,

16) Pure-Thought Navigation of the Internet & VR Metaverses,

17) Brain-Monitored Business Negotiations & Transactions,

18) Brain-Monitored Citizenship & Immigration Applications,

19) Personal Self-Improvement for Life, Health, & Fitness,

20) Monitoring of Blood-Brain Barrier Drug Crossings,

21) Human Drug Main-Effect & Side Effect Profiling,

22) Therapies for Autism and Autistic Disorders,

23) Therapies for ADD, ADHD, and other Psychological Disorders,

24) Therapies for Seizures, Epilepsy, & Migraine Headaches,

25) Therapies for Multiple Sclerosis, ALS, Lou Gehrig's Disease,

26) Therapies for Parkinson's Disease & other Neurological Disorders,

27) Therapies for Involuntary Facial Twitches & Blinking Disorders,

28) Web Browsing & Fast Internet Searches at the Speed of Thought,

29) Mouse-Cursor Point & Click,

30) Neuro-Linguistic Training,

31) Human Brain Behavioral Modification,

32) Stress Monitoring and. Stress Reduction Games & Therapies,

33) Thought to Action Engine for Magic & Super-Powers in All Worlds,

34) Emotion & Feeling Therapies for Increasing Self-Awareness,

35) Reading Comprehension & Word Misunderstanding Games,

36) Joy & Peace Therapy Games to Create Personal Peace & Joy,

37) Neuro-Plasticity Acceleration Therapy to Repair Damaged Brains, and

38) Mathematics Learning Games for All Students to Learn Math Fast.

Throughout this patent application, it is to be understood that wherever “BVRX” is mentioned,that the value of “X” may be any number of sensors.

As to Surface Facial Expressions & Emotions for Human Avatars, the BVRX Headset and Brainwave Engine can be used to learn the brainwave patterns and the facial muscle-wave patterns corresponding to each smile, wink, frown, blink, eyebrows-raised, eyebrows-furrowed, mouth-open, mouth-closed, big smile, little smile, no smile, right smirk, left smirk, eyes open, eyes closed, eyes rolling, eyes still, eyes look right, eyes look left, and other facial gestures, human facial expressions, and movements of the human face. These learned facial patterns can then be used with the Brainwave Engine, using the mathematical software method of the Apr. 24, 1997 Signal Interpretation Patent, to create a sufficient set of Interpretation Maps to Correctly and Accurately Animate the Face of a Human Avatar or Animal Avatar to that it closely matches, resembles, and mimics the Human Facial Expressions of the Individual Human Beings who is actually wearing the BVRX Headset with the 8 Integrated Brainwave Sensors.

The Facial-Expression Animated Human Avatar can then be located, activated, and deployed within any virtual space, simulated world, or metaverse for all the reasons, games, uses, and purposes of Human Facial-Expression Social VR including, face to face conversational VR, board room VR, dating VR, social chat VR, monitored facial muscle exercise VR, facial-expression therapeutic use cases, facial-muscle relaxation therapies, authentic facial-expression presence VR, poker-face VR, general social VR, social casino-game VR, and other social VR uses where a live human avatar face is helpful.

As to Deep-Brain Human Feelings of Frontal Lobe & Limbic System, the BVRX Headset and Brainwave Engine can be used to Find, Image, Capture, Record, identify, Interpret, Track, and Monitor the Full Range of Human Emotions and Feelings including the Human Emotions of Joy, Happiness, Peace, Serenity.

Facial Expression Tracking includes the capture of apparent “Surface Facial Emotions” because human emotions can sometimes be partially guessed simply by closely inspecting the surface facial features of the human face. However, the BVRX Headset and Brainwave Engine can also be used to accurately capture and monitor the more real and authentic “Deep Brain Emotions” and “Deep Brain Feelings” of the human brain, mind, and heart. The 8 Brainwave Sensors of the BVRX Headset.

The Human Limbic System is located deep inside the human brain, and this Limbic system is largely responsible for generating and maintaining the true emotional feelings and real deep emotions of a human being. The only way to accurately find, record, and capture these deep, true, limbic emotions is with an advanced technology that can measure and probe the behavior of the deep-brain limbic system activity. The BVRX Headset is such a technology because it has 8 brainwave sensors that can sense, measure, and record the electrical activity emanating from regions deep inside the human brain. No surface facial camera can capture these deep brain activity. But BVRX technology can.

As to Thought-to-Speech for Silent Human Communications, the BVRX Headset & Brainwave Engine can be used create a “Thought to Speech Engine” in which a person's language-thoughts are captured and automatically translated into audible speech. An individual's Silent Pure Word Thoughts can be correlated with Brainwave Patterns which are then interpreted and translated into Clear Spoken Speech by finding, capturing, and isolating the exact brain wave patterns that correspond to, and precede each spoken word. The Brainwave Sensors in the BVRX Headset measure and record raw electrical human brainwaves and facial muscle-waves as they flow from a. human head. These raw human brainwaves contain word-specific patterns that precede by milliseconds the actual audible speaking of the specific words.

The Brainwave VR Thought-to-Speech Engine can be used in 4 different modes as follows: i) Quiet Speaking Mode, ii) Whisper Mode, iii) Silent Mouthing Mode, iv) Pure Thought Mode.

As to a Thought to Action Engine for Animating Human Avatars, the BVRX, BVR16, and BVR32 Headsets and. Brainwave Engine can be used in the manner described in the 1997 Patent to capture human thoughts of movement and motor intentions to animate the bodies, limbs, faces, hands, feet, toes, and fingers of human avatars to help them move and navigate in virtual worlds.

As to Peak Performance Sports Training for the Human Brain & Body, the BVRX Headset & Brainwave Engine can be used to help athletes and other people improve their flow, efficiency, smoothness, accuracy, and overall performance in their sports activities, games, business transactions, decision making, movement execution, and also improve in many other areas of life. This is done by helping the athlete find and identify which brainwave patterns precede his best sports movements, and then helping him find and repeat these healthy brain wave patterns of peak performance in order to help him re-enter the flow of peaceful, focused movement-execution. This is a type of brainwave-pattern biofeedback to augment and optimize peak performance in sports, games, and every area of life.

As to Personal Brain Health & Fitness and Human Wellness Training, and Brain-Monitored Education & Learning, the BVRX Headset & Brainwave Engine can be used to closely monitor the activity of the human brain in various settings and situations where training, fitness, education and learning or the like may be the primary goal or one of the goals.

For example, it has been observed that large brain-state changes occur while reading past a misunderstood word. Similarly, math learning may be monitored. This applies to Mathematics Learning Games for Students to Learn Math Fast.

As to Personal Human Smile Training, the BVRX Headset and Brainwave Engine can he used to provide very helpful Smile-Feedback and therapeutic Personal Human Smile Training for all human beings including patients and individuals suffering from Autism, ADD, ADHD, and other types of neurological, emotional, psychosomatic, psychological, and other facial-expression disorders.

Sometimes our human smile is not as good, smooth, beautiful, handsome, clear, convincing, genuine, or sincere-looking as we want it to be. Sometimes the smile of our lips and mouth does not properly match the smile or pseudo-smile of our eyes and eye-muscles. And sometimes simply looking in an old low-tech regular common glass mirror (as we have been doing for decades) is just not enough to give us the full feedback we desire and the important information we really need about our own personal smile and other facial expressions of our very own human face. It is very helpful to see the human face and smile of our very own personal avatar in VR, and at the very same time to see indicators and signs on or near our avatar face that indicate the true nature and current flavor of our deep seated limbic brain emotions and true inner feelings.

It is very helpful to see our (1) true inner feelings, while at the same time seeing our (2) avatar face in VR, and also seeing our (3) actual face in this real world. By seeing all three of these reflections of our human emotions at the same time we can get the necessary feedback and useful information we need to help us relax into healthy healing deep brain states of peace and contentment, as our stress melts away, and we allow our true feelings of peace and tranquility and happiness reflex into our true smiles and avatar smiles in a genuine and natural way so our smiles in VR, AR, and regular base reality will be truly beautiful, handsome, genuine, sincere, natural, and very good looking. In this way we can use BVRX Technology to teach and train ourselves to have more genuine human smiles of greater beauty and genuine human warmth and truth.

As to Therapies for Involuntary Facial Twitches & Blinking Disorders, Human Brain Behavioral Modification, Stress Monitoring and Stress Reduction Games & Therapies, the necessary and immediate feedback may be provided directly to a user 12 through the headset 18 as in FIG. 11.

As to Thought-to-Action Engine for Magic & Super-Powers in all Virtual Worlds, the BVRX Headsets and Brainwave Engine can be used in the manner described above to find, capture, interpret, and translate Human Brain Thought and Human Brain Intention to move things, flip switches, change things, and do things to other things in the real world (via computers, electronics, relays, motors, actuators, etc.) and in all virtual worlds. This will effectively give all human beings (with BVR# Headsets) the super powers and magic abilities of the action heroes of Hollywood's best Fantasy Films and Science Fiction Movies.

Uses of this BVR Headset Invention has been shown to remotely control devices capable of computer and network communication. For example, the foregoing may apply to Human Facial Expression Recognition, Human Avatar Facial Animation in VR, Human Avatar Virtual Body Animation, Human Avatar Guidance, Movement, and Control, Human Emotion Detection and Tracking, Biosignal Electric Control of wheelchairs, BioSignal Control of Virtual Mouse Cursor, BioSignal Point and Click to Select Virtual Objects, and Brainwave Video Game Influence and Control.

With Soft and Comfortable, Soft, Brainwave Sensors as described hereinabove, one may monitor control, and verify individuals' Human Self-Learning, Facial Expression Recognition, Brain-State Capture, Control of Video Games, and Brainwave Control of Prosthetic Limbs. Brainwave signals may substitute for spinal cord reconnection.

The Brainwave Virtual Reality (BVR) Headset, Brainwave Engine, and Brain Operating System (BUS) constitute a BVR Technological Platform enabling the following applications: BVR Avatars: A BVR Avatar is a brainwave-controlled avatar game character in a virtual reality simulated environment that is at least partially controlled by the brainwaves (or body waves) of the brain (or body) of the human player.

BVR Dating Avatars have enhanced abilities for a better virtual dating experience for singles, couples, friends, strangers, friend groups, families, family members, business associates, members of organizations, sports teams, clubs, and other individuals and groups and people of all ages. The BVR Technology can enhance the abilities of the Dating Avatars and improve the Player-Avatar Connection to improve BVR Social Dating in many ways. BVR Facial Expression Recognition Technology allows each avatar to see its date's facial expressions live in real time to enhance the avatar dating experience.

The BVR Technology can also be used to allow an avatar to better sense it's date's moods and emotions by capturing the various brainwave patterns of distinct human emotional brain states and. making this information available to one or more of the dating avatars or dating game players. The BVR Avatar Human Emotion Interpretation, Capture, Imaging, Tracking, and Reporting for Virtual Dating, Game Playing, Emotion-Communication, Business Consultations, Job interviews, Emotional Health Assessment, and Emotion Therapy.

The BVR Technology can also be used to allow enhanced avatar-to-avatar communication during the simulated virtual dating experience. The BVR Technology can be used to capture and recognize the intended word-patterns of the brainwaves and facial muscle-waves of each human player's head and face as each word is spoken, silently mouthed, silently spoken, whispered, thought, intended, silently spoken with the mouth closed, or barely spoken, softly spoken, or spoken in a different way, or regularly spoken. The captured BVR Brainwave Word-patterns or facial muscle-wave word-patterns can then be used to provide and generate good word-synthesized clearly spoken words from one human player to another via their respective dating avatars or directly between the two human beings seeking to communicate.

Brainwave Augmented Reality (BAR) Technology that uses the silent mouthing of words to generate the audible speech of spoken words to provide more convenient BAR-assisted communications worldwide between all people. BAR Technology for human thought-to-speech recognition by capturing and interpreting the brainwave patterns that precede and generate spoken words. BVR Technology and BAR Technology for brainwave control of motors, machines, remote controlled aircraft, drones, cars, trucks, equipment. BVR & BAR Technology for the scientific study and mapping of the human brain and animal brains.

One embodiment of the foregoing may be characterized as Event Resolution Imaging (ERI). The advanced mathematical “waveform interpretation engine” intelligently sorts through massive amounts of complex data to locate meaningful information. The ERI engine is software in accordance with the invention acts as a Brain Operating System (BOS) to be applied to any type of waveform, such as sound waves, heart waves (EKG), muscle waves (EMG) and especially brain waves (EEG). By its signal processing, the ERI interpretation engine searches for the small hidden signal that is normally undetectable in the midst of a vast background of unwanted noise.

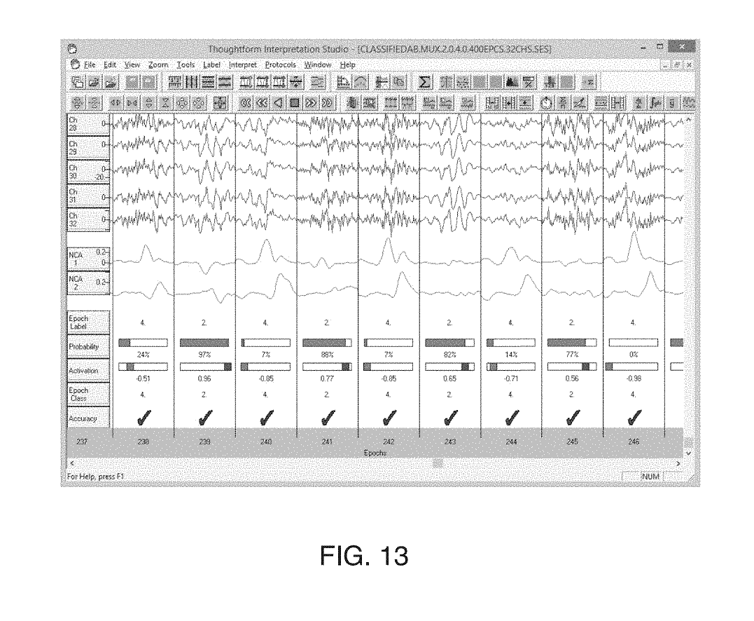

Referring to FIGS. 13 through 16, actual computer screenshots illustrate how the ERI interpretation engine worked, in some applications.

Each screenshot image basically includes some jagged lines (waveforms), followed by smoother curvy lines, then various icons and symbols at the bottom. The jagged blue lines are actual human brainwaves recorded from multiple EEG electrodes (brainwave sensors) placed on a person's scalp. These brainwaves were processed with the ERI engine to create the curvy lines, which could be called the “interpreted” waveforms. The brainwaves represent the raw data that contain small, but meaningful signals hidden somewhere in the midst of a very large amount of “background noise.” Once the ERI engine sorted through the complex blue brainwaves, it found the small hidden signals. It then amplified these signals and erased all the background noise to make them very distinct and visually noticeable. These now very crisp signals are the curvy lines.

So what are these meaningful hidden signals that the crisp, curvy lines represent? In this case, they are the alternating movements of a person's right and left thumbs. The interpreted waveform signals indicate which thumb was moved at precisely what time and for how long. Through the process of Event Resolution Imaging (ERI), what were once unimaginably complex raw brainwaves are elegantly transformed into simple quantifiable signals.

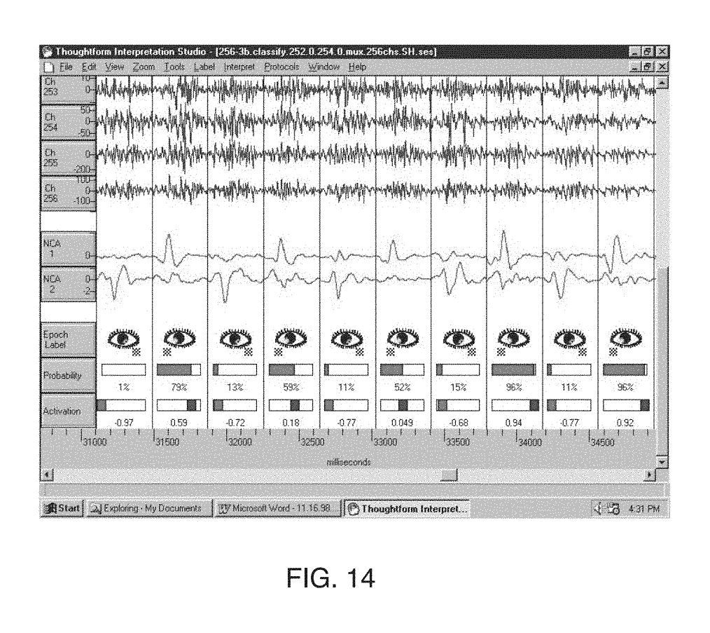

Referring to FIGS. 13 through 14, as demonstrated, the method of Event Resolution Imaging (ERI) was successfully used to interpret brainwave packets from a motor movement study on a trial by trial basis (single trial signal interpretation). While the previous example was from a brainwave study involving thumb movement detection, very similar results have been obtained from studies involving various visual, touch, cognitive, and other neurally represented human events.

The screenshot image shows ten columns of data from the study. Each 384 ms epoch (column) contains either a Lower Left Quadrant Visual Flash or a Lower Right Quadrant Visual Flash event-type. The epochs alternate by event-type, beginning with the lower left quadrant flash epochs. The epoch label indicates which event-type the epoch truly was. The epoch classification channel gives the type of epoch assigned by the method. The probability channel assigns a computer calculated probability that the epoch was a lower left quadrant flash. The activation channel gives the degree to which the epoch met the criteria for its classification, from +1 for a lower left quadrant flash to −1 for a lower right quadrant flash. Notice how the wave patterns in the Single Trial Event Related Signals (STERS) correspond to the two different event types. Also, notice that although the STERS waveforms are generally robust, they do reveal significant differences in amplitude, shape and latency between epochs of the same event-type.

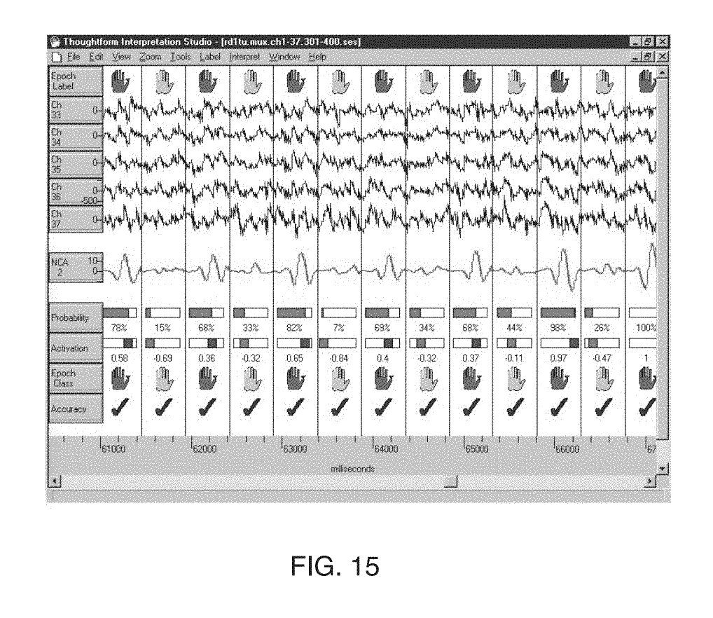

Referring to FIG. 15, a touch study screenshot shows thirteen columns of data from the study. Each 484 ms epoch (column) contains either a touched or a non-touched event-type. The epochs alternate by event-type, beginning with touched epochs. The epoch label at the top indicates which type the epoch “truly” was. The epoch classification channel gives the type of epoch assigned by the program to the epoch. The Probability channel assigns a computer-calculated probability that the epoch contained a “touch”. The Activation channel gives the degree to which the epoch met the criteria for its classification, from +1 for touched, to −1 for non-touched epochs. The Accuracy channel places a check mark if the label matches the true epoch type, an “X” if it doesn't. Notice that although the STERS touched waveforms are generally robust, they do reveal significant differences in amplitude, shape, and latency between distinct touched epochs.

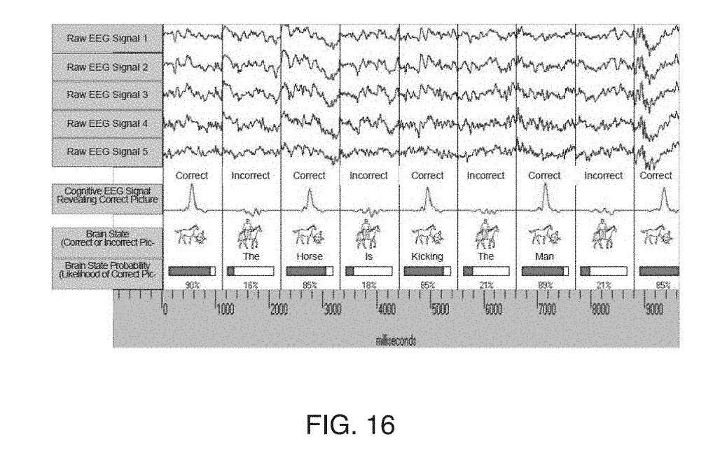

As to FIG. 16, there is no movement, no sensations, purely thinking, in a purely cognitive study human thought was tracked in milliseconds. In the cognitive comprehension study, a human subject viewed a computer screen displaying a written sentence describing a situation in a picture scene such as “The horse is kicking the man.” The subject first read the sentence and viewed a correct picture (such as a picture of a horse kicking a man) and also some incorrect pictures (such as a picture of a man sitting on a horse). The pictures were then presented sequentially (one at a time) on the screen while 5 channels of raw EEG data were recorded from the subject's scalp. Raw EEG Signals: Nine 1,100 ms epochs (columns) of Raw EEG Signal data are shown in the figure above. Note that it is difficult to visually discern discriminant patterns in the 5 Raw EEG Signal channels. Cognitive EEG Signal: The Cognitive EEG Signal channel is a highly processed combination of EEG data from the 5 Raw EEG Signal channels and 5 epochs. A particular weighting pattern has been learned (discovered) and applied to a collection of amplitude, phases, locations, frequencies and latencies to generate the Cognitive EEG Signal. Note how this Cognitive EEG Signal robustly reveals the presence of a correct picture on the display screen. The fact that the Cognitive EEG Signal exhibits striking differences between correct and incorrect pictures is an indication that the subject comprehends and understands the meaning of the particular English sentences.

The present invention may be embodied in other specific forms without departing from its purposes, functions, structures, or operational characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus comprising:
a set of sensors, each sensor thereof comprising a fabric selected to be electrically conductive and to have a hardness approximating that of flesh of a subject;
a set of leads, operably connected to the sensors away from the subject;
a signal processor operably connected to the leads to detect electrical signals originating at the set of sensors and convert those electrical signals to input signals readable by a computer;
a first computer system, operably connected to receive from the signal processor the input signals and programmed to iteratively create a plurality of interpretation maps corresponding the input signals with events representing activities of the subject;
the first computer system, programmed to minimize data processing by selecting a single interpretation map and determining events corresponding to the electrical signals based on the single interpretation map and
the first computer system, programmed to send to a second computer system remote from the first computer system a control signal instructing the second computer system to perform an action, based on the events represented by the input signals.

2. The apparatus of claim 1, wherein:
the second computer system comprises a display;
the action comprises re-creating an image of the events on the display; and
the sensors are applied to contact the face of a subject in a location selected to include at least one of above, beside, and below the eyes of the subject, the forehead below a hairline, between the eyes and the ears, and the cheeks proximate the nose and mouth of a subject.

3. The apparatus of claim 1, wherein:
the second computer comprises a controller of a device; and
the action comprises actuating the device in a manner based on the events.

4. The apparatus of claim 1, wherein the signal processor further comprises:
an amplifier corresponding to each of the leads; and
a converter converting each of the electrical signals from an analog format to a digital format readable by the first computer system.

5. The apparatus of claim 1, further comprising:
an appliance fitted to be worn by a subject on a bodily member of the subject;
the set of sensors secured to the appliance to be in contact with skin of the subject; and
the set of sensors being in contact exclusively by virtue of pressure applied to the skin by the appliance.

6. The apparatus of claim 5, wherein the appliance is selected from headgear, clothing, a sleeve wrapping around the bodily member, a glove, a sock, a boot, and a band.

7. The apparatus of claim 5, wherein the appliance completely encircles a perimeter of the bodily member.

8. The apparatus of claim 5, wherein:
the appliance comprises a mask contacting a face of a user and comprising a display portion and a sensor portion, the mask including a pressurizing material between the display portion and the sensor portion to apply pressure to the sensors against the skin.

9. The apparatus of claim 1, wherein:
the first computer is programmed with a signal interpretation engine, executable to create a signal interpretation map providing a manipulation of the signals effective to identify the event, based on the manipulation; and
the first computer is programmed with an iteration algorithm to execute the signal interpretation engine repeatedly to create a plurality of signal interpretation maps; and
the first computer is programmed with a correlation executable effective to determine a best signal interpretation map of the plurality of signal interpretation maps.

10. The apparatus of claim 9, wherein:
the first computer is programmed to receive operational data from the set of sensors in real time; and
the first computer is programmed to process the operational data by using the best signal interpretation map to identify the events occurring at the first set of sensors; and
the first computer is programmed to send to the second computer instructions controlling the remote device based on the events occurring at the first set of sensors.

11. An apparatus comprising:
a set of sensors, each sensor thereof, comprising a fabric having a hardness less than that of skin of a human;
the sensors further characterized by an electrical conductivity sufficiently high to conduct an electrical signal therethrough;
leads connecting to sensors corresponding, respectively, thereto, to conduct electrical signals from the corresponding sensors;
an initial signal processing system operably connected to the leads and comprising at least one of an amplifier, an analog-to-digital converter, and a filter;
a first computer system operably connected to the initial signal processing system;
the first computer system executing at least one of a learning executable, a verification executable, and an operational executable;
the learning, verification, and operational executables each comprising executable instructions effective to identify and distinguish from one another multiple events, each event of which corresponds to a unique set of values, based on the computer signals received by the computer system and corresponding directly with the electrical signals originating from the set of sensors.

12. The apparatus of claim 11, wherein:
a first computer system, programmed to iteratively create a plurality of interpretation maps corresponding to the input signals and the events representing activities of the subject;
the first computer system, programmed to minimize data processing by selecting a single interpretation map and determining the events corresponding to the electrical signals based on the single interpretation map and
the first computer system, programmed to send to a second computer system remote from the first computer system a control signal instructing the second computer system to perform an action, based on the events represented by the input signals.

13. The apparatus of claim 12, wherein:
the second computer system comprises a display; and
the action comprises re-creating an image representing the events on the display.

14. The apparatus of claim 12, wherein:
the second computer comprises a controller of a device; and
the action comprises actuating the device in a manner based on the events.

15. The apparatus of claim 12, wherein:
the signal processor further comprises an amplifier corresponding to each of the leads, and a converter converting each of the electrical signals from an analog format to a digital format readable by the first computer system;
the apparatus further comprises an appliance fitted to be worn by a subject on a bodily member of the subject, the set of sensors being secured to the appliance to be in contact with skin of the subject exclusively by virtue of pressure applied to the skin by the appliance.

16. The apparatus of claim 15, wherein:
the appliance is selected from headgear, a head-mounted display, a head-mounted audio-visual playback device, clothing, a sleeve wrapping around the bodily member, a glove, a sock, a boot, a mask, and a band that completely encircles a perimeter of the bodily member, a harness combining an array of electrical sensors and motion sensors, a harness containing sensors and stimulators applying electrical stimulation, the appliance including a pressurizing material to apply pressure to the sensors against the skin of the subject.

17. The apparatus of claim 11, wherein:
the first computer is programmed with a signal interpretation engine, executable to create a signal interpretation map providing a manipulation of the signals effective to identify the event, based on the manipulation; and
the first computer is programmed with an iteration algorithm to execute the signal interpretation engine repeatedly to create a plurality of signal interpretation maps; and
the first computer is programmed with a correlation executable effective to determine a best signal interpretation map of the plurality of signal interpretation maps;
the first computer is programmed to receive operational data from the set of sensors in real time; and
the first computer is programmed to process the operational data by using the best signal interpretation map to identify the events occurring at the first set of sensors; and
the first computer is programmed to send to the second computer instructions controlling the remote device based on the events occurring at the first set of sensors.

18. A method comprising:
instrumenting a mammal with sensors providing electrical signals reflecting biological activity in the mammal;
the instrumenting, wherein the sensors are selected to detect at least one of muscular activity, brain activity, neural activity, and dipole movement of a biological electrical dipole in the mammal;
providing a first data signal, comprising a first digital signal readable by a computer, by operating on the electrical signals by at least one of amplifying, converting from analog to digital, and filtering;
creating a plurality of signal interpretation maps by the computer iterating through a feature expansion process operating on the digital signal;
testing each map of the plurality of signal interpretation maps by using each map to classify a new digital signal independent from the first digital signal; and
selecting a best map from the plurality of signal interpretation maps based on the greatest accuracy in correctly labeling the events.

19. The method of claim 18, wherein:
the filtering is selected from high pass filtering, low pass filtering, notch frequency filtering, and band pass filtering;
the filtering is selected to isolate from one another at least two of muscular activity, brain activity, neural activity and biological electrical dipole activity; and
the signals comprise a first inner signal having particular correspondence to a first event constituting a biological event of the mammal, the first inner signal being characterized by a frequency in the range of from about 1 to about 200 Hertz.

20. The method of claim 19, comprising:
isolating the inner signal from the signals;
creating a signal interpretation map by processing the first inner signal by feature expansion processing;
selecting a signal interpretation map best correlating the first inner signal to the event;
receiving a second inner signal;
classifying a second inner signal precisely by manipulating the second inner signal according to the interpretation map; and
identifying an occurrence of the event based on the classifying of the second inner signal.
